(19) United States
(12) Patent Application Publication
(10) Pub. No.: US 2017/0301254 A1
(43) Pub. Date: Oct. 19, 2017

(54) Method for Teaching Individuals About the Comprehension of Religious Texts by Synchronizing Contemporaneous Print, Visual and Audio Learning Opportunities

(71) Applicant: Kathleen Andres, Decator, GA (US)

(72) Inventor: Kathleen Andres, Decator, GA (US)

(21) Appl. No.: 15/444,048

(22) Filed: Feb. 27, 2017

Related U.S. Application Data
(63) Continuation-in-part of application No. 11/528,744, filed on Sep. 28, 2006, now abandoned.
Application No. 11/528,744 is a continuation-in-part of application No. 10/125,310, filed on Apr. 18, 2002, now abandoned.
(60) Provisional application No. 60/284,858, filed on Apr. 19, 2001.
(60) Provisional application No. 60/335,744, filed on Nov. 1, 2001.

(51) Int. Cl. G09B 19/00; G06Q 30/06; G06Q 10/08; B42D 1/00; B42C 19/06; G06K 15/16; G06K 15/02

(52) U.S. Cl. CPC G09B 19/00; G06Q 30/0633; G06Q 30/0621; G06Q 10/087; G06Q 10/083; B42C 19/06; G06K 15/16; G06K 15/022; B42D 1/001; G06K 2215/101

(57) ABSTRACT

A method and resulting product of generating a bible torah or other religious text personalized to an intended recipient. The person giving the bible selects a characterization of a bible, such as a cowboy bible, truck driver's bible, lawyer's bible, children's bible, woman's bible and the like. Then the giver selects an age group of the intended recipient of the bible. Based on this information the system then presents a form for the giver to select from a list of problems experienced by said intended recipient. The giver is then given an opportunity to select additional passages from the bible or other sacred texts to be highlighted. A personalized message with sections highlighted which related to an intended recipients age and problems. This message can be a bound volume produced by the steps of feeding lightweight paper through a printer, printing using an inkjet technique or other relatively thinly deposited ink to print on said paper to result in producing printed paper, and binding said printed paper into a volume. The inventive combination may incorporate lightweight or ordinary paper in one volume of a scriptural or underlying religious text (such as the Holy Bible, the Torah, or the Qur'an) and a biographical text detailing the triumphs and hardships of the life of either a celebrated public figure or an extraordinary but seemingly every-day character. By cross-referencing these two texts, and packaging them in a single volume form where they can easily be flipped between, the teachings of a particular religious faith can be made more readily accessible to the public at large.

### CROSS REFERENCE TO RELATED APPLICATIONS

This application is a continuation-in-part of U.S. patent application Ser. No. 11/528,744 filed Sep. 28, 2006 which claims the benefit of U.S. provisional patent application No. 60/284,858 filed Apr. 19, 2001 and U.S. provisional patent application No. 60/335,744 and which claims the benefit of U.S. patent application Ser. No. 10/125,310 filed Apr. 18, 2002 the disclosures of which applications are hereby incorporated herein by reference thereto.

### FIELD OF THE INVENTION

The invention relates to devices and methods for the teaching of religion through a combination of both scriptural and foundational texts and biographical stories which exemplify the principles those works attempt to instill.

### STATEMENT REGARDING FEDERALLY SPONSORED RESEARCH OR DEVELOPMENT

Not applicable.

### BACKGROUND

The foundations of all major religions are the scriptural texts that comprise the body of literature and song associated with their development. These texts contain the principles, values, and beliefs each religion wishes to instill in its followers. Unfortunately since many of them date centuries or even millennia back in time they often require translation or adaptation to modern times. This application will disclose a method of combining and cross-referencing biographical stories with the bodies of religious works applicable. By offering a series including a variety of role models and applying the works of a variety of religions the inventor hopes to achieve a more effective method of religious instruction.

While hundreds of billions of dollars are devoted every year to the development of technologies for such things as achieving a fraction of one percent improvement in the operation of a gasoline engine, heating houses more uniformly, improving the speed of personal computers, and other such things, the improvement of people as self-motivated human beings of character and integrity as a part of society remains, in comparison, substantially untouched by technology, save for the largely counterproductive use of the media as a substitute for conventional entertainment.

This seems rather remarkable, given the importance of interpersonal reactions and relationships, and clear indicators in our society that at the turn-of-the-millennium the moral system has broken down, at the end of a century long cycle of decay. Compared to the state of moral affairs at the end of the last century, overall, there has been an increase in virtually every negative indicator of the moral health of a society. Divorces, births out of wedlock, abortions, murders, and all manner of psychological and physical violence, by and large, have risen steadily for the last hundred years.

Some have suggested that technology is the culprit. The logic behind this statement is not clear, but given the complexity of human development and reaction of human nature to various factors, there may be some truth to this. Perhaps, technology has created a world where our worst demons are nurtured and promoted. Nevertheless, despite the apparent value of technology as a tool, as alluded to above, it remains substantially untapped to address these problems. Over the years, however, an attempt to improve people has been made by distributing the Bible and other texts, for example in hotel rooms.

Moreover, print on-demand book publishing is beginning to be used in the marketplace. While many companies have developed print on-demand publishing lines; these machines and “printing lines” address the publishing needs of the paperback and hard cover mainstream book publishing industry. The papers used in these on-demand printing machines is medium to heavy in weight, compared to the thinness of the paper required in the printing of Bibles, Torahs, and other religious text.

Thus, the printing and publishing of Bibles, Torahs, and other religious text requires many diversified capabilities due to the thinness of papers used, flammability of these papers, ink compatibility, thickness of the finished book and numerous other unique printing and publishing requirements. Because of these special requirements, companies who print and publish Bibles, Torahs and other religious text have special equipment to handle the unique characteristics and properties required for publication of these books.

Bibles, Torahs and religious text are traditionally printed and published in large quantities, due to the extensive and costly pre-press operations required to “prepare for the printing” of just one book. These traditional printing and publishing requirements do not lend themselves to the customization of Bibles, Torahs and other religious text, printed in customized small runs.

Additionally, many different types of books, magazines, periodicals, reference guides, spiritual texts, travel books, invoices, direct mail pieces and the like are printed on lightweight papers. Perhaps the most familiar use of lightweight papers is in the financial industry (prospectus, financial reporting and the like) and religious text (i.e., Bibles). Conventionally, products printed using lightweight papers have used traditional printing presses such as offset printing, web, gravures and similar technologies. These traditional printing technologies generally involve the use of presses, which demand pre-press development of specialized printing materials before printing can commence. The production of these materials generally involves the production of color separations, where color printing is desired, and the preparation from the separations of printing plates, which typically comprise resinous material deposited in the pattern which one desires to print on a substrate. Such substrates are typically made of metal, paper (in the case of relatively smaller printing runs) or other suitable material. In the case of full-color printing, it is generally necessary to have four sets of plates, mainly red, blue, yellow and black in order to obtain the full range of color.

Because of these necessary and costly pre-press printing processes, companies that require items to be printed on lightweight papers must print in relatively large quantities to recoup the investment spent in the pre-press process, simply preparing to print. Thus, industry experts generally state that most books must be printed in minimum quantities of 3,600 units in order to just “break even” due to pre-press setup costs.

Digital printing allows printing to be done directly from the computer to the printer without the preparation of plates or the like.

Currently, on demand printing predominantly uses either inkjet printing technology or laser technology. On demand digital printing is changing existing business models in the printing industry. The leading on demand digital printer manufacturing companies are Indigo, IBM, OCE, Xeikon and Heidelberg. The printers marketed by these companies use laser printing technology. Laser printing involves the deposit of toner in powder form on top of the paper which one desires to print.

The toner generally comprises a fine black thermoplastic powder which is brought into contact with an electrostatic image which has been formed by the printer on the paper which is to receive the print image. The electrostatic image electrostatically attracts the toner and holds it to the paper in amounts proportional to the darkness of the image area represented by the electrostatic image. The result is the formation of a black and white toner image, which, while accurate, is subject to being disturbed by the smallest of forces. Once the deposit of toner in a given area has been completed, the paper with the toner image electrostatically secured to it is then heated.

The result is to melt the toner, causing it to adhere via capillary action to the paper. After being melted, the melted toner cools and “freezes” into solid form again. The toner and paper are then fused to each other, resulting in a substantially permanent image adhering to the paper. This process of laser printing leaves raised ink on top of the paper, thus adding volume to the paper.

Color laser printing generally involves similar principles and methods performed using different colored thermoplastic materials and multiple electrostatic images.

The high temperatures required to melt the resinous materials which serve as printing inks in laser printing would have adverse effects on lightweight paper. Accordingly, printed with digital laser printing technology is limited to heavier weights of paper. On demand digital laser printing technology is thus not employed with lightweight papers because the ink is melted onto the top of the paper at a high temperature.

Moreover, when the ink printed by on demand digital laser printing technology fuses on the page, it adds bulk, both in terms of weights and thickness, to the paper. This takes the form of slightly raised printed characters on the paper, and increases the finished thickness of any document, book or finished product, printed by on demand digital printers that employ laser technology. While the effect is not easily noticeable in the case of a single sheet, when many sheets are put together, the result is bulky and unsightly. While the effect is noticeable with heavyweight papers, such as twenty or twenty-four-pound paper stock, when lighter weight papers are used, the added thickness remains the same and is proportionately a much greater portion of the overall thickness of the document, compounding the unsightly and physically distorted appearance of the printed matter.

The problem is made more serious due to damage to the paper during the high temperature fusing operation. Additionally, the high fusing temperatures, in the case of lightweight papers, create potential flammability problems during on demand digital laser printing.

Since 1974, Billions of Customized Burger King Hamburgers have been sold to their customers after the “Have it Your Way” advertising campaign launched. The introduction of customized hamburgers to the fast food industry resulted in soaring revenues. Global companies noticed and soon began offering their customers the opportunity to buy customized products, in a myriad of different product categories and industries.

Ten years later, the Internet emerged onto the retail scene offering a new distribution channel/network for consumers and retailers. Consumers quickly sought-out online businesses offering them the ability to purchase Customized Products. Once again, Customized Product Sales Soared, as small online retailers fulfilled consumer's orders manufactured to the customer's specifications. These customized sales took market share and revenue from major corporations. Once again, global companies took note and made changes to enter the new and emerging product customization market. The Customization Revolution has grown dramatically over the past twenty years. Companies of all sizes generate lucrative profits from this distribution channel.

Customized products manufactured to the buyer's specifications are typically prepaid, non-returnable and non-refundable once the order is submitted and production begins. The Customization Business Model offers significant profits to any company able to integrate their product manufacturing and a customized product ordering process, that customers can use to create these customized product orders.

Consumers shopping online today, continue to seek-out and purchase from companies that offer product customization combined with online-purchasing capabilities for: automobiles, furniture, apparel, shoes, motorcycles, appliances, bicycles, computers, and countless other products in different categories. The customized product trend has grown parallel with online retail sales growth. Nike's direct-to-consumer online sales and product customization forecasts 30% to 50% sales increases. (source: motleyfool.com 2016). Still in 2017, the Best-Selling Book in the World—The Holy Bible—remains unavailable to be developed and purchased by a consumer as a Customized Product.

### SUMMARY OF THE INVENTION

This disclosure will support any individual seeking understanding of their religion's scriptural and foundational texts by delivering in one volume a two part book, one part consisting of an annotated version of the religious texts, the other embodying the beliefs as applied, for example, to the life of a contemporary and highly regarded member of society. The combination and cross-referencing of these two offerings in a single bound volume enables a more effective teaching of the underlying principles.

Bibles, Torahs and other religious text are books whose content is historical and whose text tends to remain constant. When one of these books is read, the words often convey different interpretations to each reader. Because of this there is a need to allow for the customization of Bibles, Torahs and other religious books in keeping with the specific reading requirements of the reader. This invention addresses such a need, while developing spiritual knowledge and its relevancy of and to the individual.

The invention has as its object the use of modern information technology to advance the cause of character development, particularly in the case of younger people both in the family, in business, and in society.

In accordance with the invention, it is recognized that great wisdom has been distilled over the ages and is represented embodied in the religious texts, such as the Old Testament and the Gospel. The invention deals with the problem of successfully implementing these very general teachings in the very specific environment of a particular family or a particular workplace, school, or the like.

In accordance with the invention, it is recognized that the very general nature of the teachings of the Bible, while interesting from a philosophical and academic standpoint, in the hurried world which we have today do not easily lend themselves to quick understanding of their relevance to particular circumstances in our current society. Moreover, few people have the means to have a paid teacher who will explain the relevance of various parts of the Bible to what they're doing and the way that they ought to be living their lives.

Part of the problem is the need for this sort of assistance on a repetitive basis, and at a time when an individual is mentally free to accept new ideas and consider them as they apply to his or her life.

The Bible is not easy to understand. This writer remembers the admonition to “turn the other cheek” if you are struck. What does that mean? As a child, did the writer even have a remote idea of a meaning of this simple short statement? Does it mean that a true follower of God will not ever hurt another person? Or, does it mean that the faithful child of the Almighty will never strike in anger? Or perhaps, turning the other cheek is a statement of disbelief in the evil manifested and a challenge to the other individual to recognize the meaningless nature of anger and striking out, and a challenge to look within himself or herself for that elegant solution which would make such counterproductive behavior unnecessary, and even more plainly embarrassing.

Or perhaps, it is a demonstration of the strength of the person who has been struck, an invitation to a person being consumed with anger to cure himself and take the strength of a true believer, and gain the inner peace and happiness that comes with accepting God in every way.

These ideas are as universal as they are long recognized. For example, considering the last example, while we might consider all these thoughts purely a part of the Judeo-Christian ethic, they also lie at the very heart of the Muslim religion, where the very word “Muslim” (incorporating the “s”, “1” and “m” consonants found in full words meeting peace in the semetic languages, as exemplified by the words “salaam”, “shalom” and “Islam”) itself means peace, and, in particular, an individual who has gained peace upon accepting God through the acceptance of the Muslim religion.

In accordance with the invention, a person who may be acting as a mentor and who is thus familiar with the problems facing a particular individual in need of guidance, perhaps a child or younger associate in business has the possibility of generating a personalized message based on his knowledge of the Bible, or other sacred text, useful to such a mentored person.

In accordance with a preferred embodiment of the invention, the personalized message takes the form of a personalized printed bible, compact discs, e-books, audiovisual, text, or illustrated text work, or a work comprising a combination of these and/or other similar elements. More particularly, in accordance with a preferred embodiment of the invention, a customized version of the Bible, or other similar work, is generated by the person giving a Bible as a gift, or acquired for their own personal use. More particularly, the Bible is customized to emphasize messages of particular importance to the mentored person.

Such personalization and emphasis may take the form of certain passages being printed in different colors, highlighted or being associated with illustrations from everyday life showing the situations where the particular text is relevant. At the same time, the illustrations can be surprising and entertaining as they are associated with text written thousands of years ago, emphasizing the remarkable nature, universal applicability and ageless wisdom of the text.

For example, if such a Bible were to be given by a civil rights leader to followers who must face insult, threats and physical abuse, the text respecting “turning the other cheek” could be printed in purple and listed in a special appendix. At the same time, a picture of an individual, like the individual receiving the Bible, receiving some physical abuse which that individual faces everyday, or perhaps some mental abuse or insult, would drive the point home. In addition, explanatory text relevant to the daily life of the mentored person may also be included.

In accordance with the invention, such personalized Bibles are generated by computer. The computer is programmed to have the entire text of the Bible, together with numerous types and examples of illustrations, lessons and commentary associated with various parts of the Bible and available for selection or the person customizing the bible has the ability to add their own personal information and illustration. In addition, the computer is also programmed to receive information respecting what text is to be highlighted and what text is to be printed in selected colors and potentially underlined.

In accordance with the invention, an individual accessing the computer has the opportunity of selecting the text to be printed in the color of their choice, what text will be printed in large type having selected words and/or scripture highlighted, and having this emphasized text printed in a special table of contents. In addition, the individual may select appropriate pictures for various texts, as well as appropriate lessons and commentary associated with the same. These may be put in the context of footnotes, or on a blank facing page. People familiar with the particular medium being used will see other obvious customization options.

In addition, in accordance with the invention, the mentor is given the opportunity of typing in his/her own commentary or lesson, and adding his/her own photograph by having the same scanned and input into the computer generating the Bible, or other sacred text.

In accordance with the preferred embodiment of the invention, the computer program in accordance with the invention may be accessed by any personal computer via the Internet or at any location where such system is made available and the individual may purchase such a Bible over the Internet or elsewhere. In accordance with modern technology, books may be generated one at a time on a custom basis. The details involved in such generation will be discussed below.

In accordance with the invention, the end result is that a very personalized message of great moral and philosophical suasion, custom tailored to exactly those areas where a mentored individual is likely to be able to improve themselves can be economically, quickly and efficiently generated. Such Bibles or other religious texts can be as personalized as a Bible given by a father to his son, a grandfather to all his children, a sales manager to all his salesman, or teacher in a poor violent school district to all or none of his or her students, or a business leader to all of his clients. The emphasis on various parts of the Bible, their illustration, and a hard person to person contact (that will make the message so much more meaningful and respected) results in an impact that no general teaching can have, given the great diversity of the various people involved.

Moreover, such personalized Bibles can be stored at the web site or other location where orders for such Bibles are taken or on the personal computer of the person buying the Bible, for later modification as the mentored individual or individuals experience improvement, and, perhaps, less fortunately, experience new problems.

It is also contemplated that pre-personalized texts (directed to, for example, school children, salesmen, under-privileged children, privileged children, etc.), ready for further modification, may be made available to customers.

It is a particularly useful feature of the present invention that the mentor's guidance is embodied in physical form and thus is available at all hours of the day and night, whenever the individual has an open mind and the time, and the lack of distraction to consider the message, perhaps at a time of particular personal need, stress, depression, joy, happiness or accomplishment. Moreover, in accordance with the invention, the personalized mentoring help is there, over, and over again, whenever, wherever and as many times as it is needed.

The inventor further provides a method, system and process for the customization and subsequent on-demand manufacture of Bibles, Torahs and other religious text. The method addresses the selection of the sections to be included in the customized Bible, Torah and other religious text. The system addressed in this invention allows for the manufacture of both hard-cover, paperback and electronic Bibles, Torahs and other religious text.

Being able to print directly from a computer to a printing press greatly changes the way that companies which are in the business of selling printed products, can operate. In addition, the use of inkjet printing can greatly streamline and offer flexibility in printing operations. Inkjet printing on lightweight papers can make smaller print runs of lightweight paper products 1) possible at competitive costs, 2) customization and personalization of the item being printed an option, and 3) with greater flexibility for the individual or company purchasing or producing the printed items.

The term “lightweight papers” herein means papers which weigh less then 50 grams per square meter, coated or uncoated. Such papers in weights going as low as 39 grams per square meter have been run successfully. While these papers are below the approved paper specification weights for the Scitex VersaMark.™. inkjet printers, tests of print runs using such papers and such presses were successful.

In the case of a Bible, Torah, Koran or other spiritual text, if the inventive process for printing using an inkjet printer on lightweight paper is employed, such books can be customized to a user as noted in co-pending U.S. Patent Application 60/284,858, the disclosure and priority of which is incorporated herein by reference hereto. Moreover, such books manufactured using inkjet printing technology printed on lightweight paper are easy to store and move from place to place. It is important to note that the content of spiritual text can often be extremely difficult to read and understand. When a Bible or other spiritual text is developed and customized for an individual's specific interest it is believed that, for example, a Bible will be read and studied more often, thus sales will increase.

In accordance with the invention which is the subject of this application and the invention described in the above-noted United States patent application, the on demand digital inkjet printing technology of Bibles or other spiritual texts can be purchased with special scriptures highlighted in the color of choice of the purchaser and with individual sections included which are important to each Bible reader. Having the ability to select and customize the Bible's special sections, highlight scripture that is important to the reader, and allow for different scripture to be printed in different colors, will greatly allow for the customization of Bibles and other spiritual texts using on demand digital inkjet printing technology.

Should an individual want to develop a bible or other spiritual text and highlight the verses and scriptures that are “important or special” to him or her, such a spiritual text may be developed for users of a particular class by suitable software.

In the case of travel directories, a traveler may be planning a trip to different countries throughout the world or cities in the United States where he has never traveled before. In accordance with the invention, such a traveler logs onto an Internet website where he can customize a book for his specific travel plans. He selects the countries and/or cities where he will be traveling. Next he chooses those types of things which are of interest to him (museums, sporting events, historical landmarks, hotels, restaurants, etc.), noting the dates when he will be traveling. The system then searches the database for responsive information and presents the same to the consumer of the travel guide who is given the opportunity to include proposed information in his travel guide.

A customized travel book is thus developed for the traveler because of the answers to questions asked. This travel book is developed, personalized and printed for a specific trip or trips and customized to the traveler's special interests. Once the traveler has answered the questions and made selections online and the book is paid for, it is printed, bound and mailed to the traveler. The traveler will then need only to travel with one travel guide that contains information pertinent to his specific itinerary, as opposed to one book for each city or country he wishes to visit.

With the use of inkjet printing on lightweight paper, the book will be lightweight, easy to use and customized to the travel and special interests of the individual or individuals traveling. If there are multiple travelers, each traveler's special interests can be printed in a color they have selected, or in a separate section.

A feasibility study, comprising a comprehensive laboratory evaluation was conducted on eight paper samples manufactured by PDL, a European manufacturer of lightweight papers. The objective of this evaluation was to examine the feasibility of such papers for lightweight book publication.

Of the eight samples, two (Lacopaque and Microlux 36 gsm) show favorable optical density (print quality) and show thru when printed on an ordinary printer. The evaluation of these results suggests that a run of Lacopaque and Microlux on a Scitex nine inch printer might yield favorable results. Two rolls, 9.5 inch wide and 40 inch diameter on three inch core, of Lacopaque and Microlux are used.

### BRIEF DESCRIPTION OF THE DRAWINGS

The invention may be understood from the following drawings in conjunction with the description which follows:

FIG. 1 is a diagram that indicates the purchaser being given the ability to choose between a hard-cover book or an electronic format being the final delivery method of the customized Bible, Torah and other religious text;

FIG. 2 is a block diagram of the selection of choices that the purchaser of a customized Bible, Torah and religious text will be able to choose from;

FIG. 3 is a block diagram of the different potential cover colors;

FIG. 4 is a diagram of the different possible sizes that hard-cover customized Bibles, Torahs and religious text can be printed in;

FIG. 5 is a block diagram of the different potential translation choices;

FIG. 6 is a block diagram of the potential different languages available;

FIG. 7 is a block diagram of the potential nationality picture colors available;

FIG. 8 is a block diagram of the potential layout formats that can be printed;

FIG. 9 is a block diagram of the many different possible sections that can be included in the front and back sections of the customized Bibles, Torahs, and religious text. These sections may be placed throughout the customized Bible, Torah, or religious text being purchased;

FIG. 10 is a block diagram of the different ways that verses can be printed;

FIG. 11 is a diagram showing an example of a customized Bible that was created by the purchaser using the steps outlined in FIGS. 1-10;

FIG. 12 is a diagram of the manufacturing process that a customized Bible, Torah and/or religious text will go through to be made, once the purchaser has made their selections, as outlined in FIGS. 1-10;

FIG. 13 is a perspective view of the obverse of an inventive volume with one of the biographical testimonies face-up;

FIG. 14 is a perspective view of the reverse of an inventive volume with the religious testimony face-up;

FIG. 15 is a perspective view of the obverse of the inventive volume of FIG. 1 opened the title page;

FIG. 16 is a perspective view of the obverse of the inventive volume of FIG. 1 with the cover turned opened and text of a subsequent page exposed;

FIG. 17 is a perspective view of the reverse of an inventive volume with the cover open and inside text visible;

FIG. 18 illustrates the obverse cover of a celebrity biographical story (Oprah Winfrey);

FIG. 19 illustrates the obverse cover of a hero's biographical story (exceptional tales about everyday people);

FIG. 20 illustrates the obverse cover of a leader's biographical story Jimmy Carter);

FIG. 21 illustrates the obverse cover of a legend's biographical story (Princess Diana);

FIG. 22 is a diagram that illustrates the welcome page of the inventive book development platform;

FIG. 23 illustrates the religious selection page of the inventive book development platform;

FIG. 24 illustrates the religious book selection page of the inventive book development platform;

FIG. 25 illustrates the translation selection page of the inventive book development platform;

FIG. 26 illustrates the scripture selection page of the inventive book development platform;

FIG. 27 illustrates the scripture embellishment page of the inventive book development platform;

FIG. 28 illustrates the story selection page of the inventive book development platform;

FIG. 29 illustrates the informational content selection page of the inventive book development platform;

FIG. 30 illustrates the information content selection with printed code technology symbol page of the inventive book development platform;

FIG. 31 illustrates the information content selection with printed code technology symbol page of the inventive book development platform;

FIG. 32 illustrates the selected scripture embellishments page of the inventive book development platform;

FIG. 33 illustrates the selected scripture embellishments page of the inventive book development platform; and

FIG. 34 illustrates the database of the inventive book development platform.

### DESCRIPTION OF THE INVENTION

All religions have either one main scriptural and foundational text or several texts which compile the main teachings, principles, and beliefs of the religion which they address. These books comprise a religion's scriptural and foundational basis. In addition there are books of song which correlate to hymns, chants and other music related stories and songs specific to the religion for which they were written. This application addresses these scriptural and foundational texts and song related books.

The number of different religions followed throughout the world is extensive. The scriptural and foundational texts associated with the most well-known of the world religions are as follows: members of the Christian faith rely primarily on the Holy Bible, there have been many attempts to make this text more understandable in diverse individualized translations but the text itself has always been comprised of 66 separate books as told in the Old Testament and the New Testament; members of the Catholic Religion, in addition to relying upon the Holy Bible find their basic beliefs in the Nicene Creed, the Catholic Catechism, the Ten Commandments, and others; in the Jewish religion the main scriptural and foundational text is the Torah, further texts include the Talmud, the Haftera, the Tanakh, and books of Chants; in the Islamic religion the foundational text is the Qur'an, with the Tafsir of Ibn Kathir being the most renowned and accepted explanation thereof; members of the Church of Jesus Christ of the Latter-day Saints, known popularly as Mormons rely upon the Book of Mormon as a companion to the Holy Bible; in the Buddhist religion the foundational text revolves around the Four Noble Truths; lastly, members of the Hindu religion rely upon the Vedas as their original scriptures of Hindu teachings and the Upanishads as the core of Indian philosophy.

During the centuries, numerous different translations have been written for each of the aforementioned scriptural and foundational texts for all religions. The stories are often passed down through generations and involve innumerable characters and plots. As a result scriptural and foundational texts are not easy to read. Translations often attempt to present an easily digestible version appropriate to our current society and time.

Achieving an understandable, relevant translation has always presented a challenge for religious scholars. Translations can easily reproduce the stories on their face, but conveying the underlying meanings within scriptures and foundational texts is quite a different matter.

Believers of all religions labor repeatedly in an effort to better understand the teachings, meanings and spiritual beliefs of their chosen faith. They attend classes and religious services in hopes to achieve a true understanding. Believers often endeavor to achieve a greater understanding of their own religion by attracting others to that specific faith. Again here, attracting new members can often be easily achieved, but ensuring that new members will achieve a complete knowledge of the faith is more difficult. It may take years of reading, studying and attending classes and services.

Yet another difficulty in the structure of modern worship is that people no longer feel truly connected with God. Going to church just makes people feel good and has become a social event in their lives. With great valor this group of individuals attends regular services, and bible study groups, they do mission work, and most importantly go through the routines that any other Christian affiliated member may do. Unfortunately the sad truth is that while members of a religion or congregation may look like a well-knit group of individuals who are close to God, from the outside looking in, many of these people do not know how to identify God working in their lives.

In the past decade there have been many multi-million best-selling books which deal with God, spirituality, and faith. The Left Behind book series, which tells fictional stories about what will happen if you do not have faith in God, has sold over 55 million copies in the past nine years. The Purpose Driven Life, a book that attempts to teach its readers how to do God's will for their life, has sold over 23 million copies. The Da Vinci Code has become a movie and there are over 11 million copies of the book in print. These books deal with forming a closer relationship between their readers and God, identifying God working in the reader's life, or trying to teach the reader why they should have a close personal relationship with God and what can happen if they do not.

The problem presented is that religions with established doctrines are lacking simple, effective ways to reach out to the millions of individuals who either do not attend formal services or otherwise desire a closer, more personal relationship with God. These individuals are often well-educated, make a nice living, yet want more from life than material possessions. The books disclosed in this application will address the need of these people by filling this void in their life.

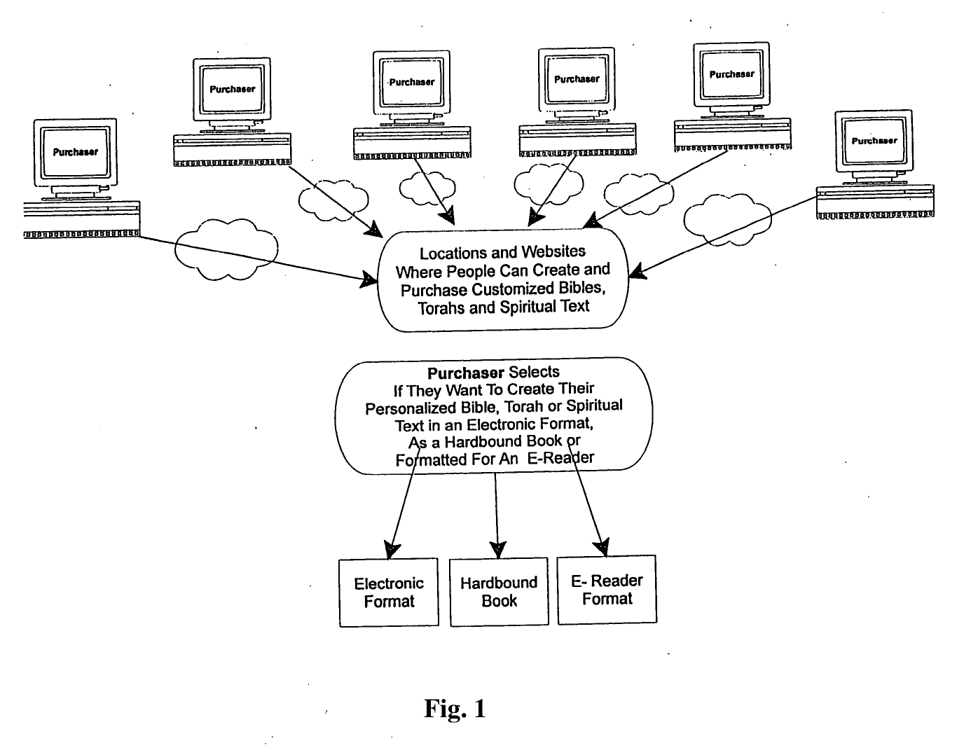

FIG. 1 is a diagram in which the purchaser of a Bible, Torah and/or Religious Text selects the method they would like to receive their customized document in. By allowing users the ability to choose between a hard-cover book and an e-reader format, we are able to address the reading needs of different individuals. FIG. 1 represents the first decision that an individual purchasing a customized Bible, Torah and/or Religious Text must make.

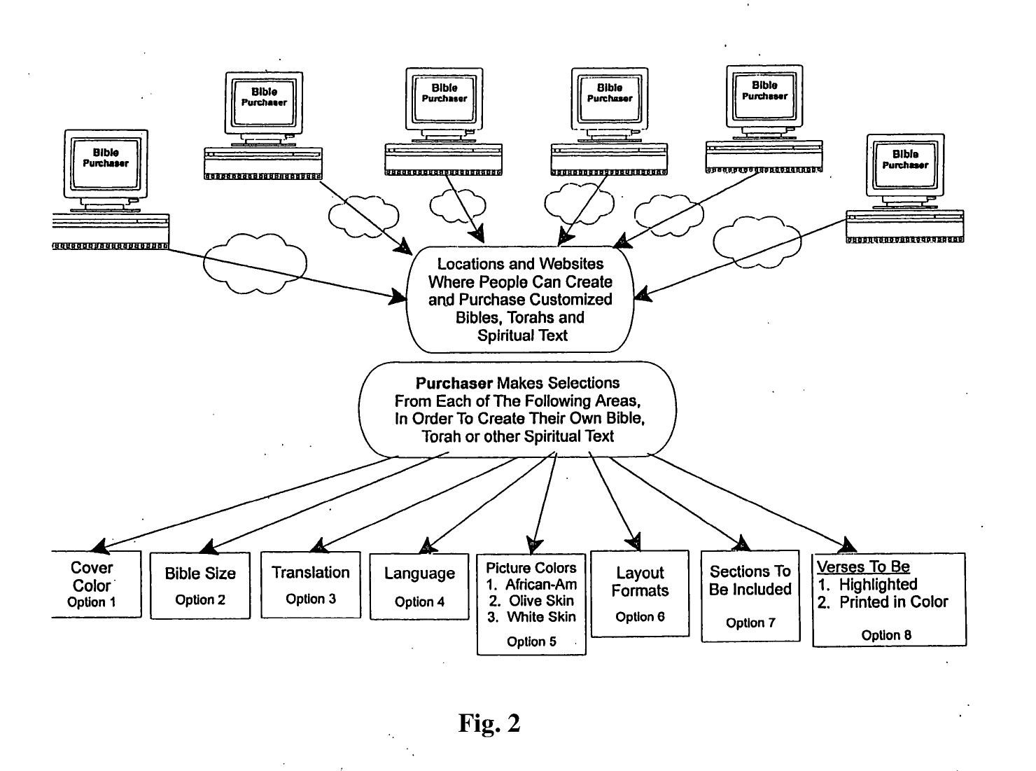

FIG. 2 is a block diagram of various different Choices that a purchaser must make in order to create a customized Bible, Torah and/or Religious Text. While the choices stated in this description are broad, it should be noted that they may change from time to time; with new additions being included. It is important that the purchaser view all the different choices they will need to make at the beginning of the process.

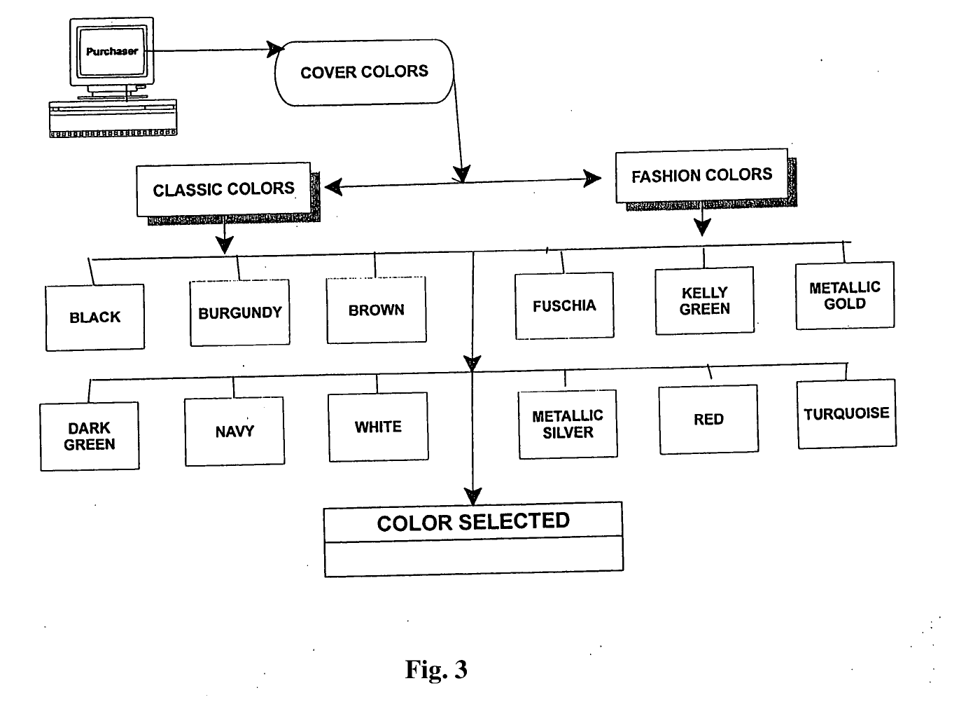

FIG. 3 is a diagram of the different Cover Colors available to choose from for a customized Bible, Torah or Religious Text. Allowing a purchaser to have their book published in a variety of different colors is new to the religious industry. Once a selection is made the purchaser can know that their Bible, Torah or Religious text can be unique to them, from the cover color on the outside to the contents herewith.

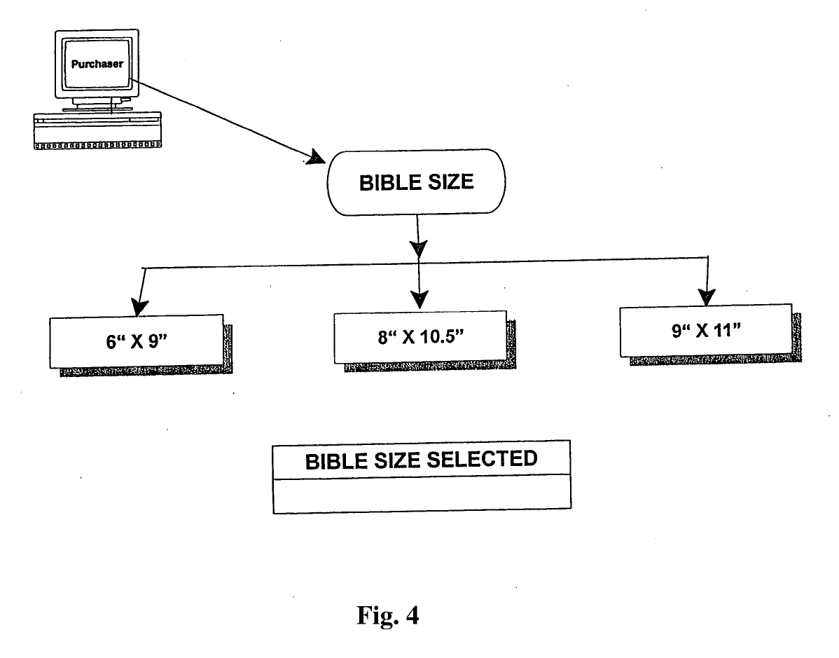

FIG. 4 is a diagram of the different Sizes of hard-bound Bibles, Torahs, and other Religious Text to choose from. In order to be able to mass-produce these customized books there are only certain finished sizes that the books can be published in. These sizes may change as new advancements in the desired printing machinery occurs.

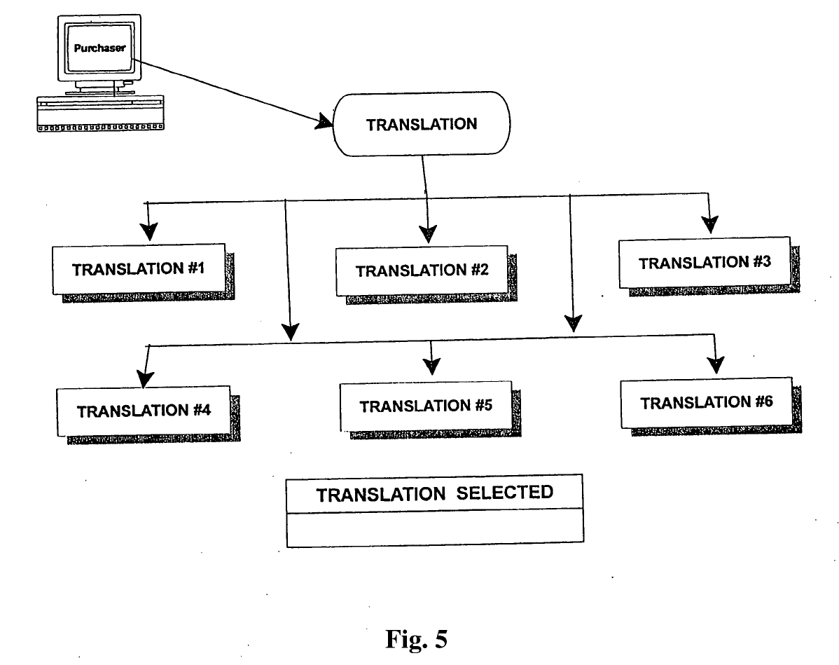

FIG. 5 is a diagram of the different Translations offered for these customized Bibles, Torahs and Religious Text. Translations, a unique interpretation of the original text of a Bible by religious scholars, have traditionally been a most important aspect in the selection of a Bible by a purchaser. By allowing purchasers the opportunity to select from a number of different translations or versions it is deemed that the customized Bible or other religious text will hold significance to the reader. Once this selection is made it is entered into a database that will be reviewed at the end of the development process defined in this invention.

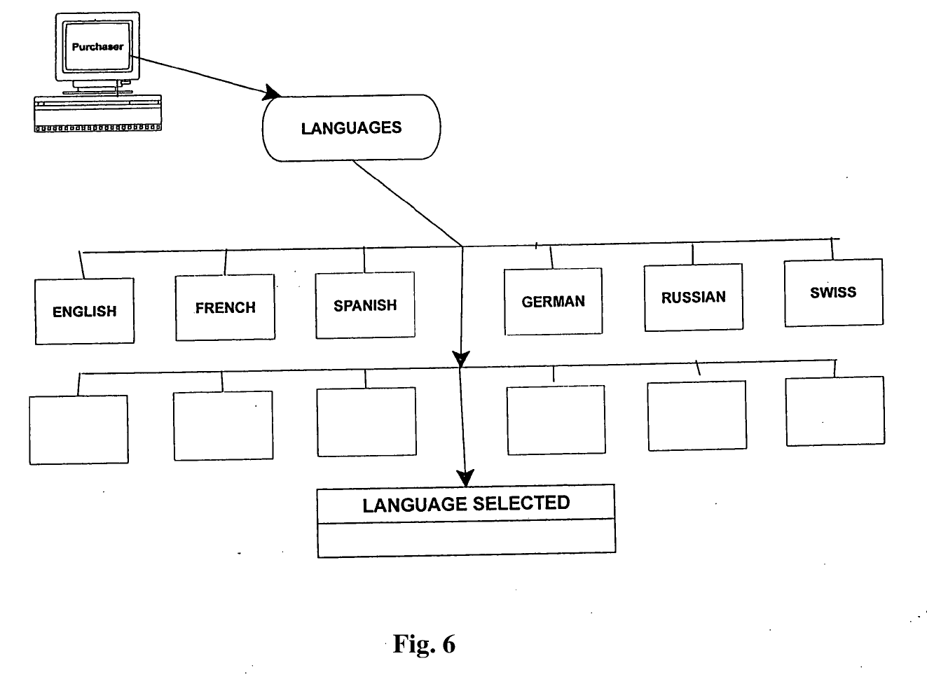

FIG. 6 is a diagram of the potential different Languages that these customized Bibles, Torahs and Religious Text will be offered in. This feature in the customization process will support the fact that these books, e-reader text or otherwise electronically created books may be sold primarily via Internet domains developed for the World Wide Web at retail stores, kiosks or the like. By allowing individuals from throughout the world to purchase customized products, one must also be able to support their native language, which is what this selection will do. The language selected will be entered into a database that will be compiled at the end of the development process defined in this invention.

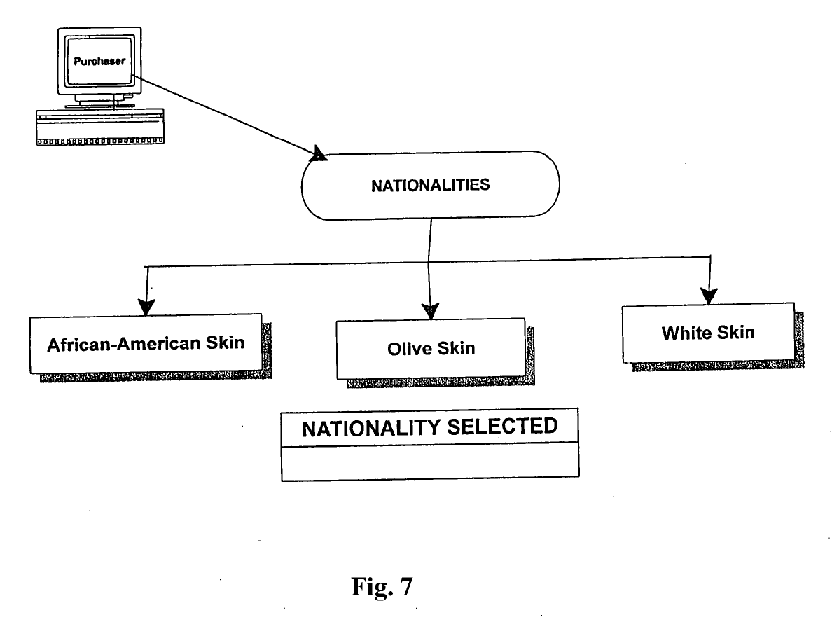

FIG. 7 is a diagram of the potential different Nationality Picture Colors that these customized Bibles, Torahs and Religious Text can be offered in. This feature allows for purchasers of different nationalities to have pictures from their nationality included in their customized Bibles, Torahs and Religious Text.

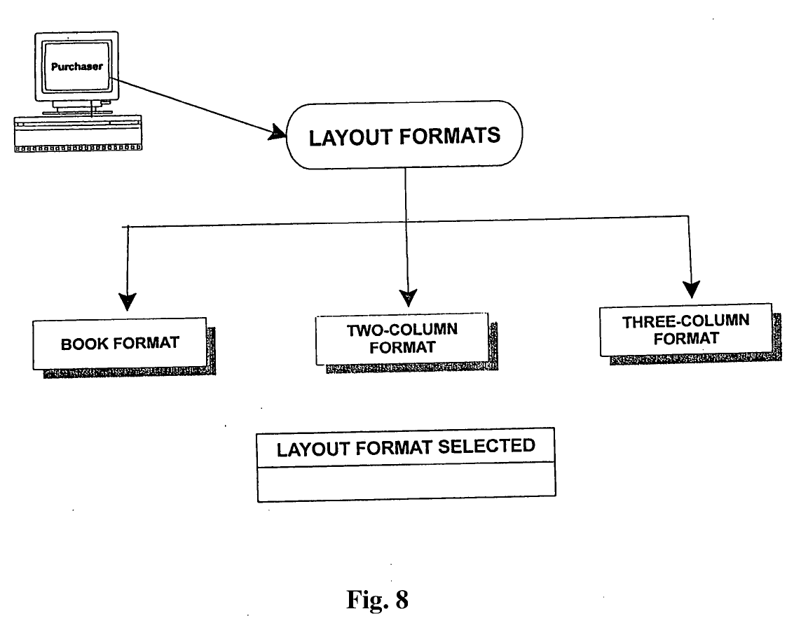

FIG. 8 is an overview diagram of the Layout Formats that can be used in the customization process. Allowing the purchaser the ability to decide which format they would like to read their Bible, Torah and/or Religious Text supports the understanding that these books are uniquely interpreted by each reader and thus the reader should be allowed the opportunity to select their personal preferences.

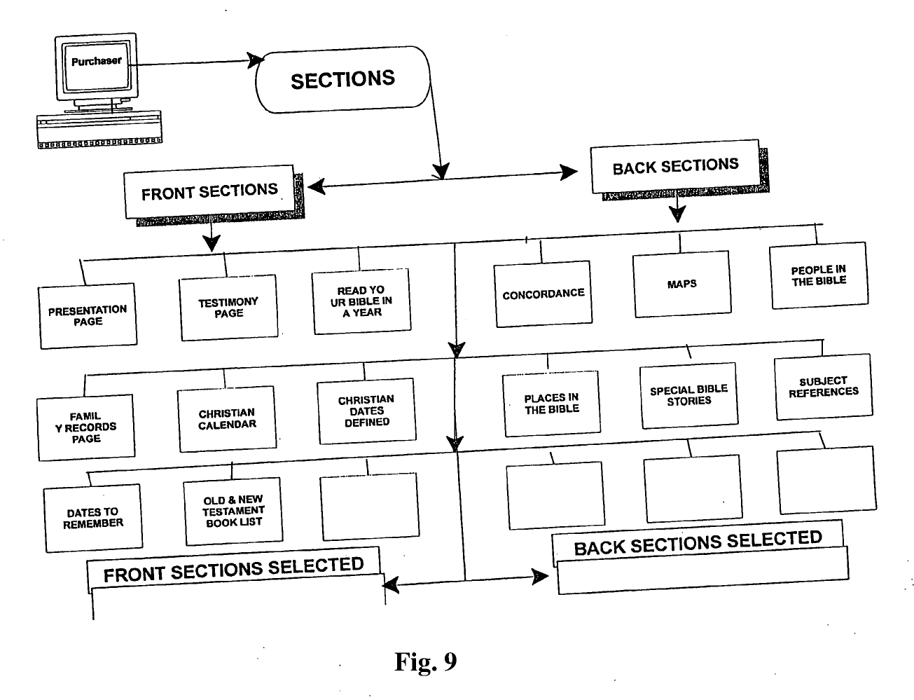

FIG. 9 is a block diagram of some of the various different sections that can be included in a customized Bible, Torah and religious text. This process had been divided into the front and back sections. This division of front and back sections was made to assure that it was easy to understand how to create a Bible, Torah and/or religious text for on-demand production. While these Sections appear relevant in today's marketplace, it should be noted that other Sections may be introduced into this invention, as it is deemed necessary.

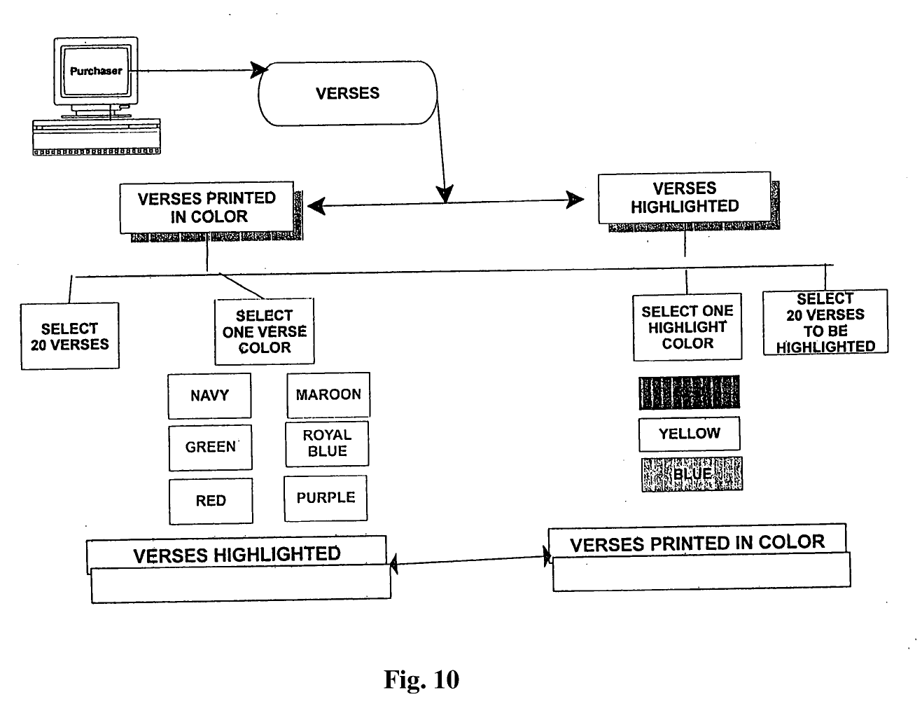

FIG. 10 is a diagram of another featured process of this invention that allows for the unique customization of verses. This process is to aid those developing a customized Bible, Torah and religious text the ability to select scripture and verses that are important to them. The process of selecting these special scriptures and verses is via a drop down menu of Bible verses. The user then selects the color the first set of selected verses will be printed in. The second process that must be decided is which verses will be highlighted and the color the purchaser has selected to highlight verses in.

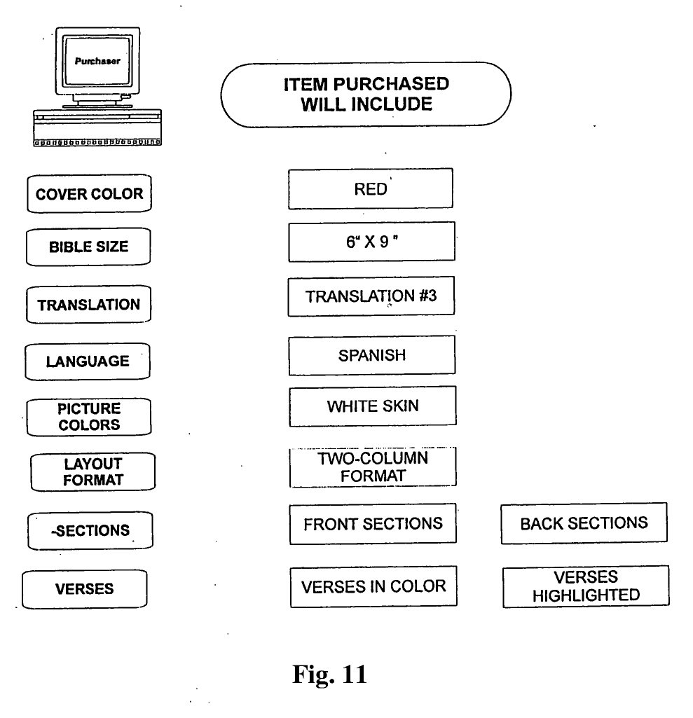

FIG. 11 is a diagram showing all selections made throughout the customization process of the Bible, Torah and religious text, as defined in this invention. This figure allows the purchaser the ability to review their selections and make changes before as the purchaser deems necessary.

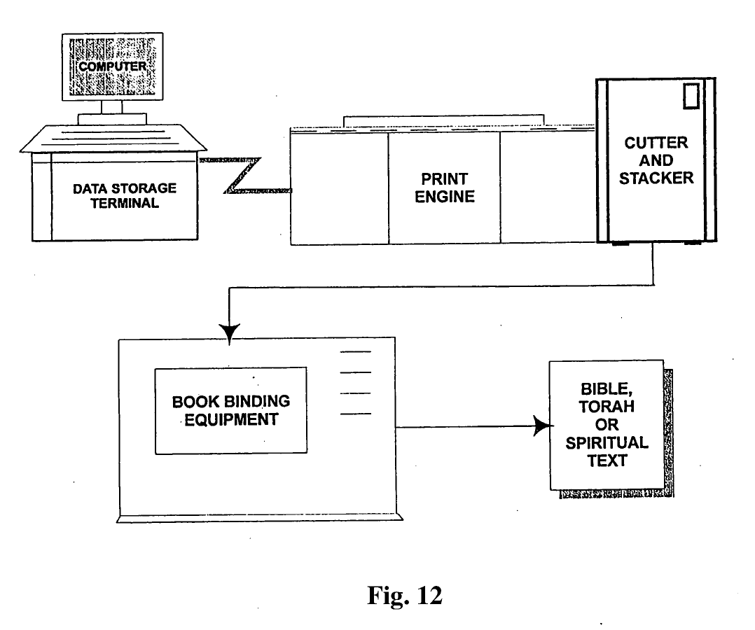

FIG. 12 is a diagram showing the manufacturing process that each customized Bible, Torah and/or religious text must go through in order to be produced.

A method, system and process for the customization of Bibles, Torahs and other religious text has been disclosed. Software written according to the present invention is to be stored in some form of computer-related medium, such as memory or CD ROM, or transmitted over a network by a processor.

Should an individual want to develop a bible or other spiritual text and highlight the verses and scriptures that are “important or special” to him or her, such a spiritual text may be developed for users of a particular class by suitable software.

In the case of travel directories, a traveler may be planning a trip to different countries throughout the world or cities in the United States where he has never traveled before. In accordance with the invention, such a traveler logs onto an Internet website where he can customize a book for his specific travel plans. He selects the countries and/or cities where he will be traveling. Next he chooses those types of things which are of interest to him (museums, sporting events, historical landmarks, hotels, restaurants, etc.), noting the dates when he will be traveling. The system then searches the database for responsive information and presents the same to the consumer of the travel guide who is then given the opportunity to include proposed information in his travel guide.

A customized travel book is thus developed for the traveler because of the answers to questions asked. This travel book is developed, personalized and printed for a specific trip or trips and customized to the traveler's special interests. Once the traveler has answered the questions and made selections online and the book is paid for, it is printed, bound and mailed to the traveler. The traveler will then need only to travel with one travel guide that contains information pertinent to his specific itinerary, as opposed to one book for each city or country he wishes to visit.

With the use of inkjet printing on lightweight paper the book will be lightweight, easy to use and customized to the travel and special interests of the individual or individuals traveling. If there are multiple travelers, each traveler's special interests can be printed in a color they have selected, or in a separate section.

A feasibility study, comprising a comprehensive laboratory evaluation was conducted on eight lightweight paper samples (comprising Lacopoque, Microlux, Adrige, Primalux, as examples) manufactured by PDL, a European manufacturer of lightweight papers. The objective of this evaluation was to examine the feasibility of such papers for lightweight book publication.

Of the eight samples, two (Lacopaque and Microlux 36 gsm) show favorable optical density (print quality) and show thru when printed on an ordinary printer. The evaluation of these results suggests that a run of Lacopaque and Microlux on a Scitex nine inch printer might yield favorable results.

An inkjet printer was used to print because, unlike conventional xerographic printing, the type is thin and will not result in a perceivable thickening of the book at the central type bearing portion of the printed and bound volume. This is the definition of the term thin in this application. It will be appreciated that the thickness of type that may be tolerated without a visual perception of increased thickness is greater for numbers of pages.

Two rolls, 9.5 inch wide and 40 inch diameter on three inch core, of Lacopaque and Microlux are used.

### Conclusions

Of the eight samples, two (Lacopaque and Microlux 36 gsm) show favorable optical density (print quality) and show thru when printed on the Scitex nine inch printer. However, Lacopaque gives the highest optical density (1.3) at a show thru of 0.22. This compared with an optical density of 1.16 and show thru a 0.31 with Microlux 36 gsm is.

All of the eight samples show good optical density irrespective of where they are printed.

All of the eight samples show high show thru irrespective of where they are printed. However, some samples give significantly lower show thru.

None of the samples show any feathering when printed at some facilities although some samples when they are printed at other facilities show feathering. This suggests that some familiarity with the printers, a component for those samples printed at Facility 2, is important to obtaining optimal results.

### Example 1

A comprehensive laboratory evaluation is conducted on the paper samples. The purpose of this evaluation is to examine the feasibility of PDL paper for the Bible publication. The objective is to assess the properties of the paper samples printed at different facilities and compare. Eight un-printed paper samples from PDL are printed using “8400A” ink at seven levels (referred to as pattern #9 to 17). The printer head used is nine inches. The print quality (O.D.—optical density) and show thru of the paper samples are measured. However, in the case of some of the paper samples printed at facility one, measurements are made at the highest level of ink only.

The test results of this laboratory evaluation are summarized in Table I. As shown in Table I, all of the eight samples show higher print quality (optical density) with the increase in the level of ink (increased pattern #). Show thru also increases with the increase in the level of ink. None of the samples show feathering when printed at Facility 2.

In the case of Lacopaque (sample #1), the optical density is in a wide range (0.82-1.3) compared to all of the other samples. However, the show thru remains in a narrow range. Even at the highest level of ink (pattern #17), which gives the highest optical density, the show thru is relatively small. When printed at Facility 1, Lacopaque also shows good optical density (1.23) but the show thru is very high. Feathering is not shown when printed at either facility. Based on the relatively high optical density and low show thru (e.g. pattern #17), Lacopaque appears to be the best performing among the eight paper samples tested.

### Example 2

In case of Microlux 36 gsm (sample #5), the optical density is in a narrow range (1.08-1.16). However, the show thru also remains in a relatively narrow range. It also does not show any feathering when printed at either facility. Based on the moderate optical density and low show thru, Microlux 36 gsm appears to be the second best performing among the eight paper samples tested.

Although both Lacopaque and Microlux 36 gsm give good print quality and low show thru (0.19-0.25 range), at least one typical industry acceptable limit for show thru is 0.06 for an 80 gsm sheet. However, given the acceptability of the product produced in the above samples (as compared to commercial offset printing examples), it would appear that the above results define a show thru standard for low basis weight (30-40 gsm) sheets.

### Example 3

In case of Primalux (sample #2), the optical density is in the range of 0.99-1.17. However, it gives moderate to high show thru. It also shows feathering when printed at Facility 1.

### Examples 4 and 5

Compared to Primalux, similar results are obtained with both the Indolux samples (sample #3 and #4). However, the lower basis weight sample (#4) showed higher show thru as expected.

### Example 6

In the case of Microlux 28 gsm (sample #6), the optical density is good and remains in a narrow range (1.08-1.18). However, the show thru is very high. It also shows feathering when printed at Facility 1.

### Example 7

In case of Adige (sample #7), the optical density is good but the sample exhibited high show thru. It does not show any feathering when printed at either facility.

### Example 8

In case of the Bible sample (sample #8), the optical density is in a fairly wide range (0.88-1.2). Both the optical density and show thru are low at lower ink levels (pattern #9-11). It does not show any feathering when printed at either facility.

As shown in Table I, all of the eight samples, in general, showed higher print quality (optical density) and lower show thru when printed at Facility 2 compared with those when printed at Facility 1.

A web-fed printing evaluation is also conducted on two additional paper sample rolls from PDL at Facility 2. The objective of this evaluation is to examine the feasibility of PDL paper for Bible publication.

Of the three sample rolls (Lacopaque 40 gsm, Primalux 39 gsm and Adige 40 gsm) evaluated, two (Lacopaque and Primalux) are printed. Both papers show favorable optical density (print quality) and show thru. Adige was printed on a drum. All three samples show varying degree of sizing, Primalux being the lowest and Adige being the highest and Lacopaque being somewhere in between on a relative basis. All three samples show low curl and cockle but Adige appears to be the best. In terms of permanence, Primalux gives a significantly better result than Lacopaque or Adige. This suggests strongly that Primalux is the most suitable substrate for Bible printing.

Two paper rolls (Lacopaque and Primalux) show favorable optical density (print quality) and show thru when printed on a web-fed printer. The third roll (Adige), when printed on a drum, also shows favorable optical density.

All three samples show a varying degree of sizing, Primalux being the lowest and Adige being the highest and Lacopaque being somewhere in between on a relative basis. However, all three samples show low HST numbers.

In terms of permanence, Primalux gave a significantly better result than Lacopaque or Adige. This also suggests Primalux to be the most suitable paper of those tested for the Bible printing.

All three samples show low curl and cockle but Adige (printed on a drum) appears to be the best in this respect.

It is believed that papers having a relatively higher HST value as compared to Primalux will result in imparting lower curl and cockle characteristics to the finished printed sheet.

During a second web-fed printing evaluation, two paper roll samples from PDL, are evaluated. The purpose of this evaluation is to ascertain the feasibility of PDL paper for the Bible publication. This also gives an opportunity to assess the runnability of the paper sample rolls on a Scitex printer. Three different paper sample rolls (Lacopaque 40 gsm, Primalux 39 gsm and Adige 40 gsm) from PDL are employed. Two of the sample rolls (Lacopaque and Primalux) are printed and the third one (Adige) is printed on a drum. The printer head used is nine inches and the ink is 1036. In the case of Lacopaque, printing is conducted at various speeds from 50 feet per minute to 350 feet per minute. However, when the paper is run at a speed above 250 feet per minute, it shows a tendency to wrinkle in the printed area. This could be attributed to the low basis weight of the sheet. Primalux was printed at 50 fpm.

Some of the important properties of the printed papers such as print quality (O.D.—14 optical density), show thru, HST (Hercules Size Test), permanence, curl and cockle are measured. Table II summarizes the results. Some of the manufacturing conditions and properties of paper measured by PDL are also summarized in Table III.

As shown in Table II, both samples (Lacopaque and Primalux) printed show good print quality (optical density). It should be pointed out, however, that the optical density is measured at the images with the highest concentration of ink. Therefore, the optical density of the text (alphabets) would be somewhat less (e.g. 0.85-0.90 not shown in Table II).

As shown in Table II, both of the samples (Lacopaque and Primalux) printed show low show thru (0.10 and 0.11 respectively) considering the low basis weight of the paper samples.

As shown in Table II, all three samples show varying degrees of sizing, Primalux showing the lowest HST number (2.6 seconds) and Adige showing the highest HST number (33 seconds). Lacopaque scored somewhere in between the two on a relative basis. The lowest HST number for Primalux could, primarily, be due to the absence of any sizing agent in the size press (Table III). The lowest HST number for Primalux is also clearly reflected in the high Cobb value (20-40 g/sm, Table III), as expected.

However, all three samples, in general, show low HST numbers. Based on recent study, it is believed that, in general, a paper sheet with high HST performs better in terms of curl and cockle. Therefore, a high HST is desirable especially in case of papers with low basis weights.

In terms of permanence, Primalux shows a significantly better result than Lacopaque and Adige which makes the former a more suitable one for Bible printing. The improved permanence exhibited by Primalux could, primarily, be attributed to its porosity (20-40 ml/min, Table III). In addition, Primalux has a pigmented surface coating and high ash content (Table III). However, permanence may also depend, to some extent, on the kind of ink used.

As shown in Table II, all three samples showed low curl and cockle but Adige (printed on a drum) appears to be the best. This can be attributed to its relatively high HST number (33 seconds) as discussed earlier. TABLE-US-00001 TABLE IV Properties of Three Paper Rolls from PDL for Bible Publication Permanence Sample # Paper B.W. (gsm) Pattern # O.D. Show Thru HST (sec) (10=Best) Curl Cockle Comments 1. Primalux 39 Curl 10 1.21 0.12 2.6 6 low low Best in overall performance 2. Lacopaque 40 Curl 10 1.20 0.10 14 2 low low Needs improvement

TABLE-US-00002 TABLE II Properties of Three Paper Rolls from PDL for Bible Publication Permanence Sample # Paper B.W. (gsm) Pattern # O.D. Show Thru HST (sec) (10=Best) Curl Cockle Comments 1. Primalux 39 Curl 10 1.21 0.12 2.6 6 low low Best in overall performance 2. Lacopaque 40 Curl 10 1.20 0.10 14 2 low low Needs improvement 3. Adige* 40 Curl 10 1.08 0.09 33 2 v. low v. low Should do well in curl cockle *Printed on a drum

TABLE-US-00003 TABLE III Manufacturing Conditions and Properties of Paper Measured at Facility Adige 40 gsm MM Primalux Lacopaque Specs Blue white MM 39 gsm 40 gsm blanc 120 Basis weight gsm 40 39 40 Basis weight text 27.0 26.3 27.0 Furnish composition % Hardwood/soft wood 67%/33% 58%/42% 67%/33% Schopper Riegler level .degree. SR 35 50 55 Internal treatment Cationic starch % Yes Yes Yes Anionic polyacrylamide Yes Yes Yes Polychlorosulfate agent Yes Yes Yes Sizing agent (AKD) 0.11% dry 0.10% 0.14% Surface treatment Pigmented surface treatment 1.5 gsm to 2.0 gsm/face dry Potato starch 0.7 to 1.3 gsm dry/face No 0.7 to 1.3 gsm dry/face Sizing agent AKD % 0.01% dry/paper No 0.06% dry/paper Insolubilizing agent Yes No Yes nature Poly-Hydroxylated Poly-Hydroxylated resin resin Optical brightening agent Yes Yes No Ash content (1472.degree. F.) 14-16 total(I+S) 22-24 14-16 Filler content % (752.degree. P) 16-18 total(I+S) 26-28 19-21 Nature CaCo3 1-3 CaCo3 6-8 CaCo3 8-10 TiO2.about.4 TiO2 TiO2 4-6 KC.about.10 KC+K KC 5-6 Smoothness FS & WS 10-50/20-60 60-80/80-100 Bendtson method nl/mn Porosity ml/min 300-500 (360) 20-40 150 Cobb g/sm 15.4 20-40 16-20

In connection with the above discussion, it is noted that the tests are carried out on paper which is not designed for inkjet printing. Rather, such papers are designed for offset printing. Accordingly, it is believed that such papers tend to soak up more ink than they should, and conventional techniques as are applied to paper to improve its functioning in connection with inkjet printing, such as coating, special chemistries or the like will improve high-speed printing in connection with inkjet printing technologies.

As illustrated in FIG. 13, the present invention may take the form of a spiritual book 10 with or without lightweight paper that incorporates two texts, one part is a religious text 18, the other is a biographical story 14, and they are bound together with a single spine 22. The books are bound back to back, oriented in opposite directions vertically, so by flipping the book over each side can be viewed properly. The series would be comprised of the “Flip Bible,” “Flip Torah,” “Flip Qur'an,” each paired with an appropriate corresponding biographical work.

Book 10 comprises a front cover 24 and a rear cover 26 and a number of pages bound therebetween, for example by being secured to spline 22. Any binding technique used for making a book, whether or not it includes a spine, may be used to make the inventive book. For example, so-called perfect binding, classical binding techniques, glue binding, or the like may be used. Likewise, the inventive book may be made by printing and folding a plurality of sheets and stapling them at the fold point, using a technique known as saddle stitching.

FIG. 14 illustrates book 10, after it has been flipped over from left to right and turned upside down. Thus reverse cover 26 is oriented upside down with respect to obverse cover 24.

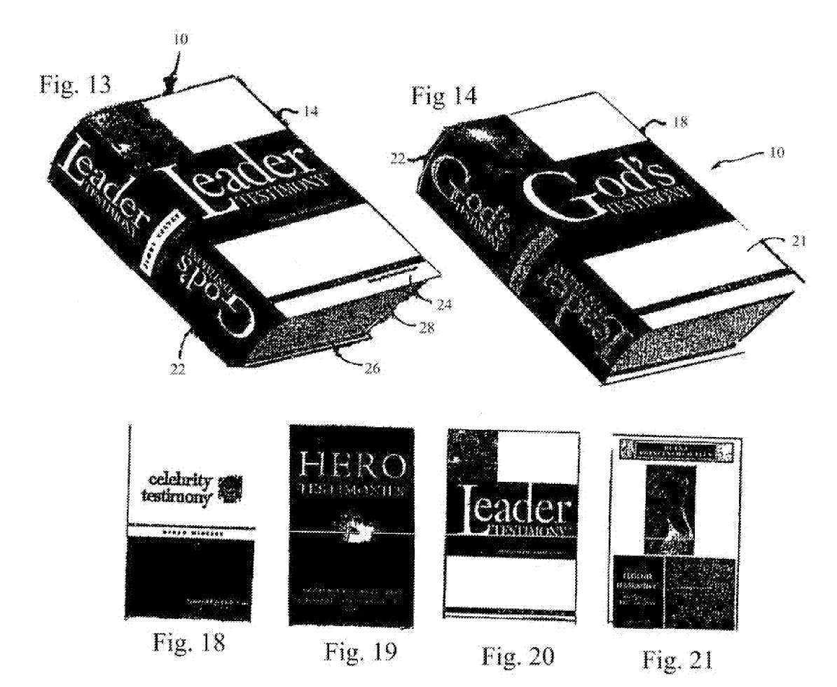

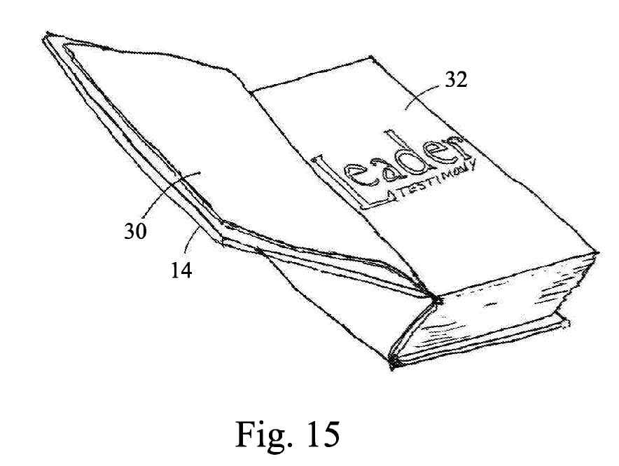

When the inventive book 10 is oriented in the position shown in FIG. 13, cover 24 and one or more pages 30 may be opened to reveal, for example, a cover page 32, as illustrated in FIG. 15. The print on page 32 is oriented the same way as the print on cover 24.

More particularly, as illustrated in FIG. 15, on page 32, the print for the word “leader” is oriented the same way as the print for that word on cover 24.

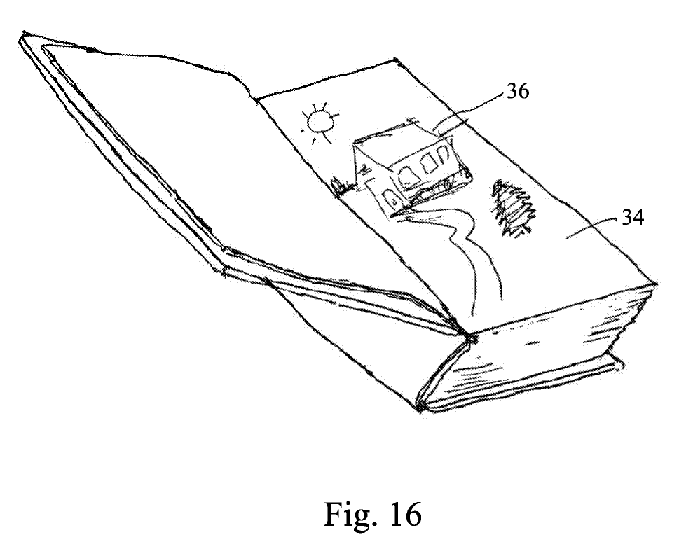

As illustrated in FIG. 16, further turning of pages may reveal illustrations and text with an inspiring story about a world leader, for example including a page 34 including an illustration of a humble house 36, where a recognized leader began life's journey. In accordance with the present invention, it is contemplated that the story of such a leader would inspire certain individuals. It is further contemplated that different individuals may require different role models and different examples of life stories which took advantage of strengths of character or overcame prejudices or problems on the road toward a successful life.

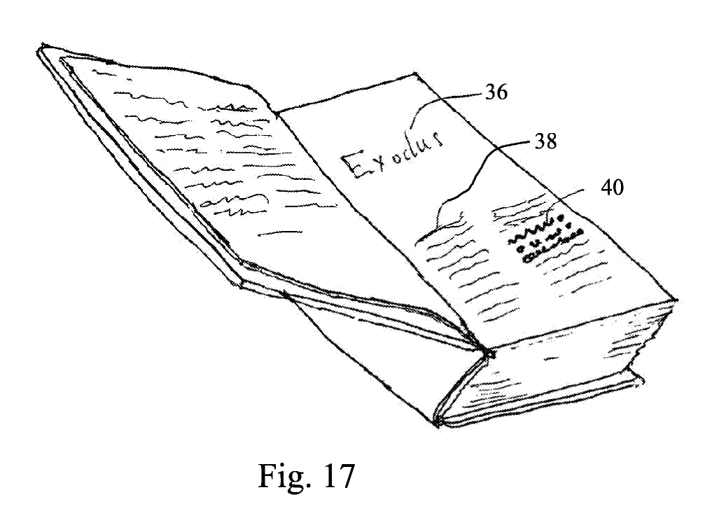

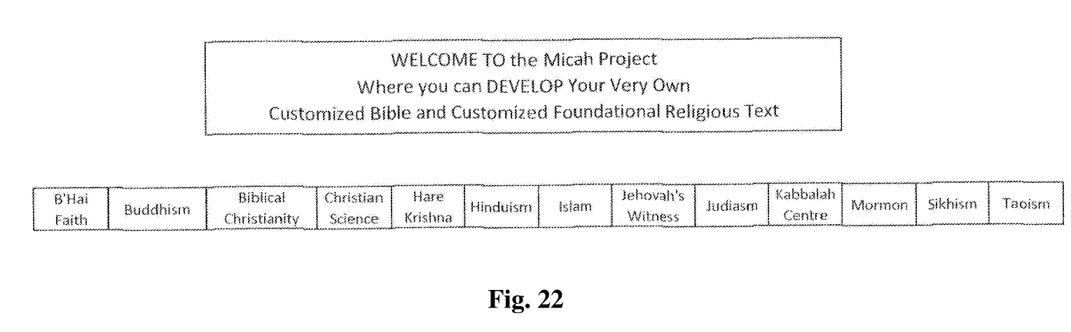

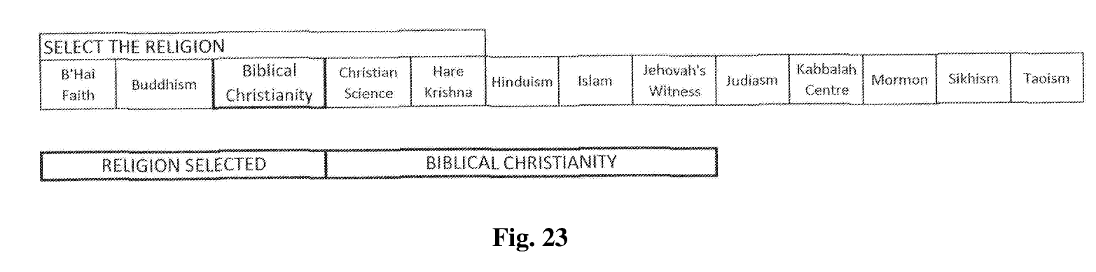

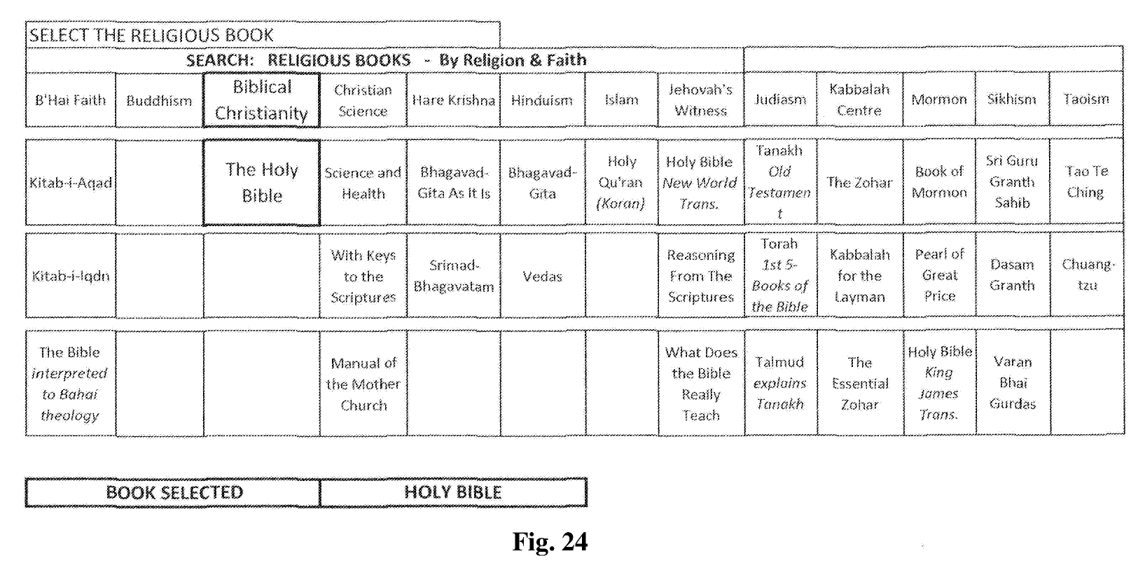

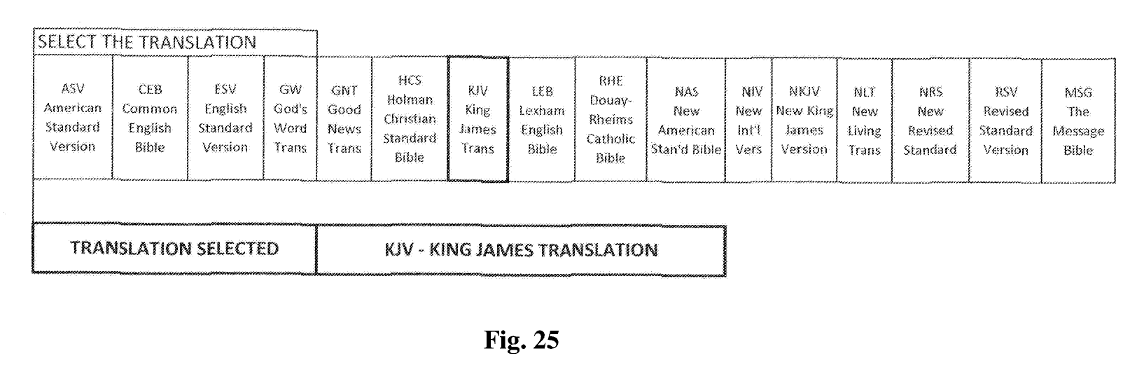

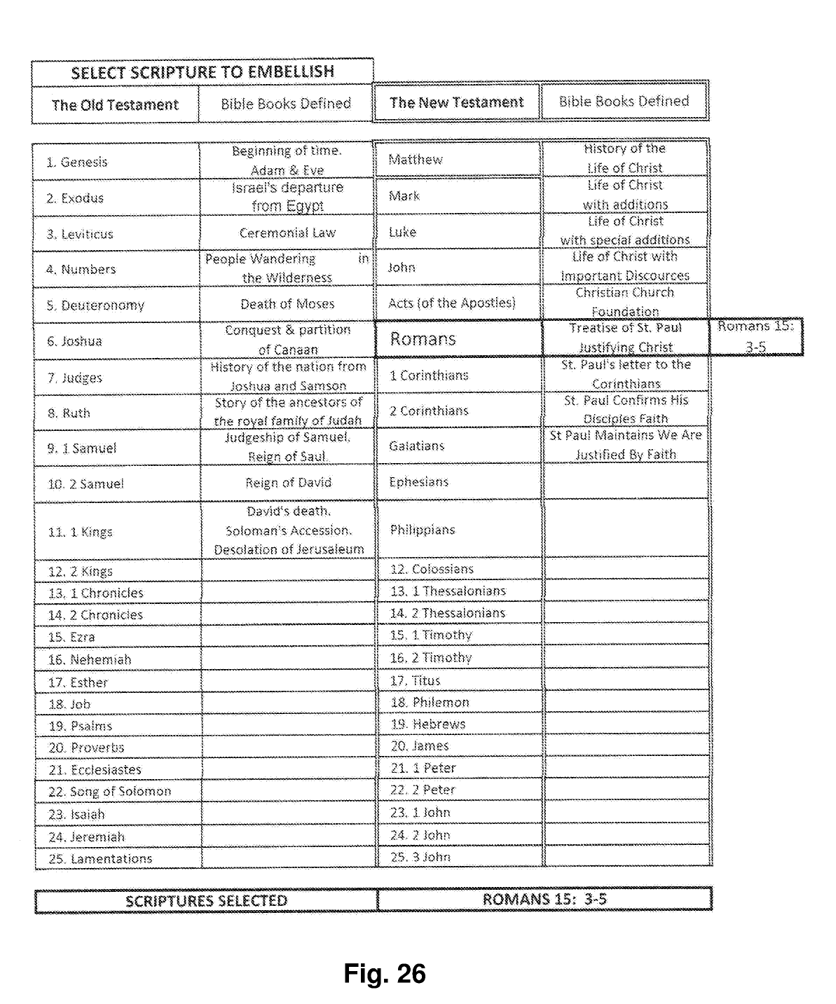

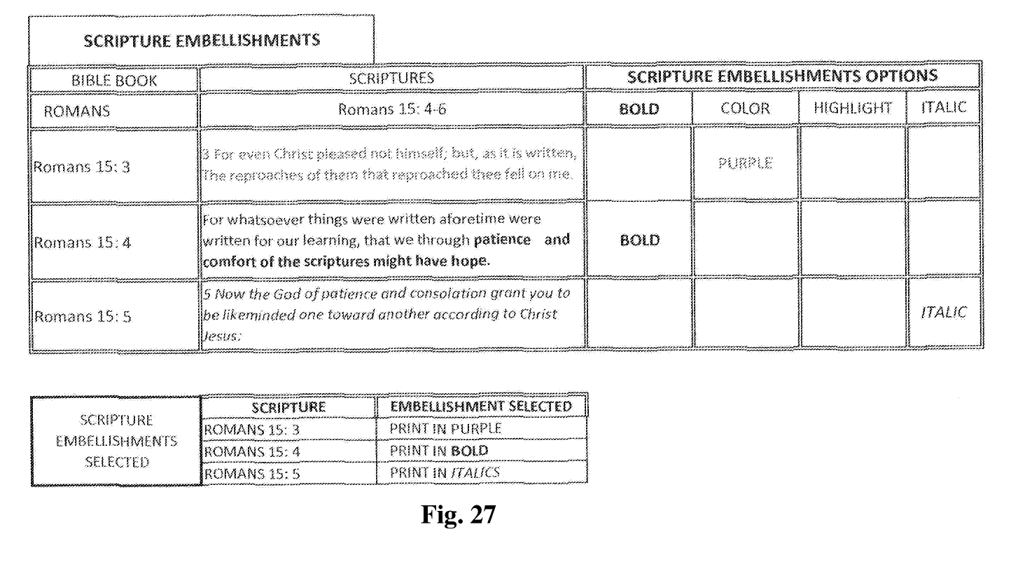

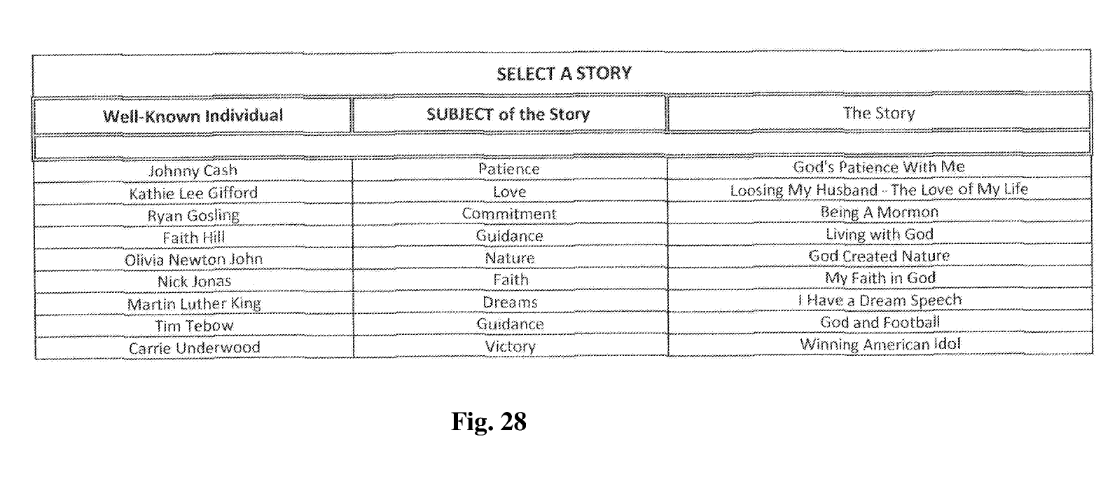

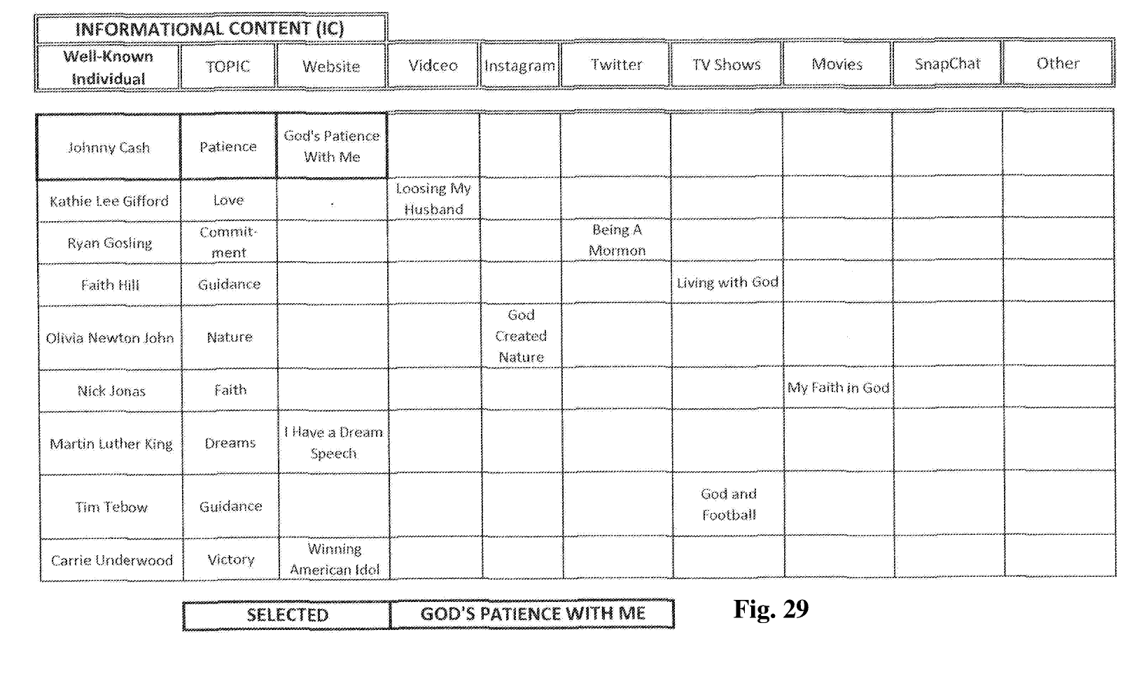

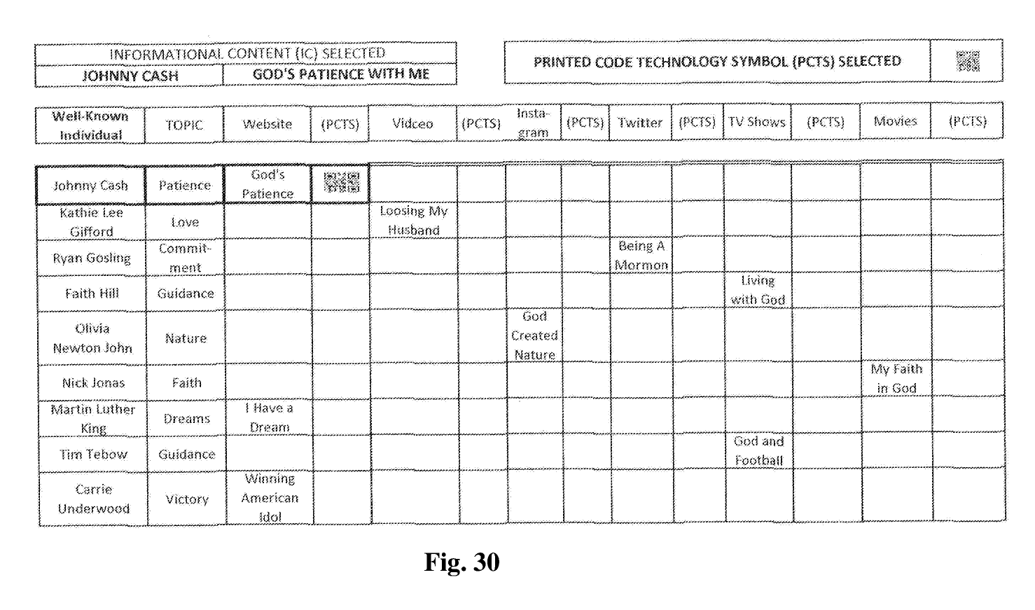

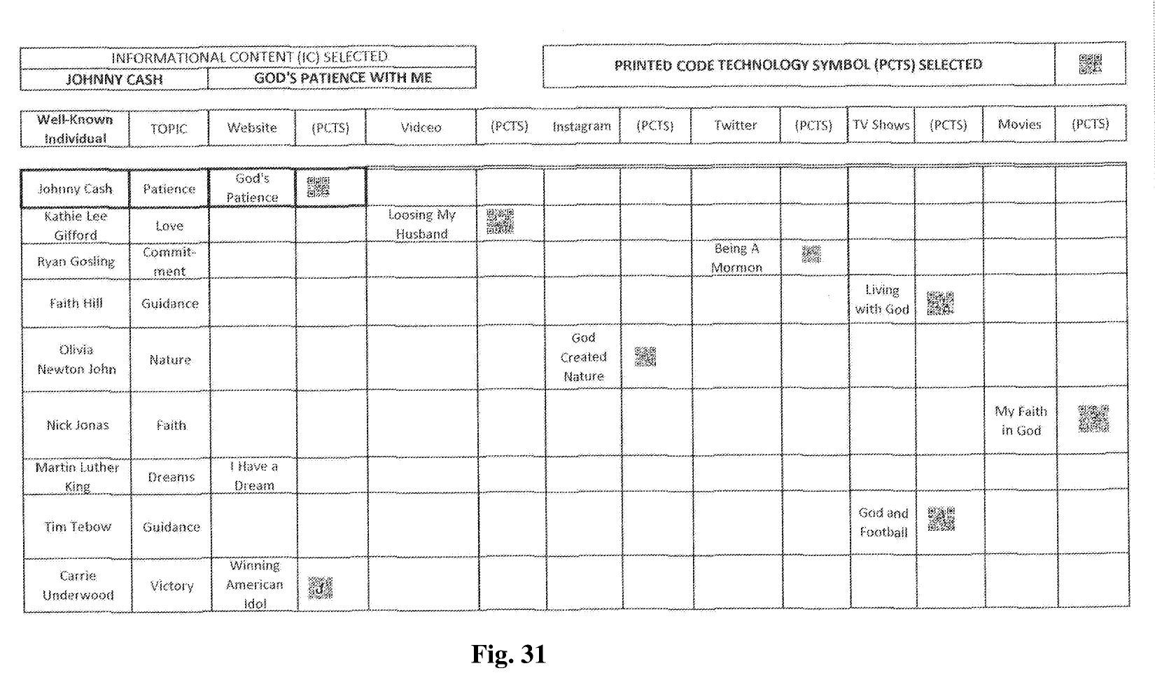

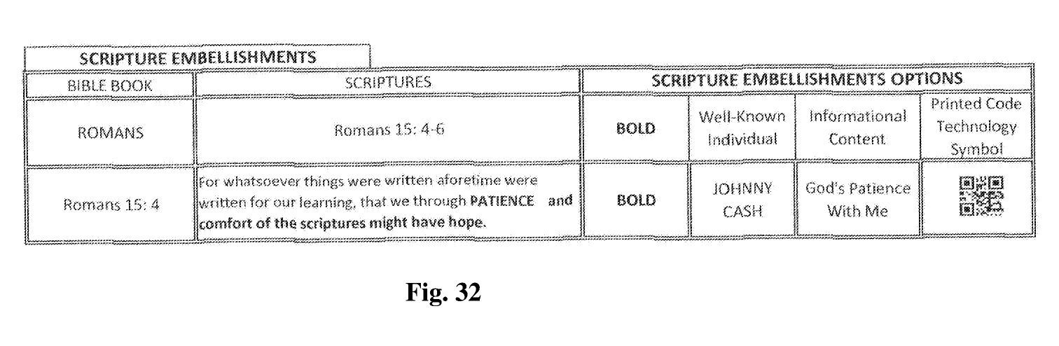

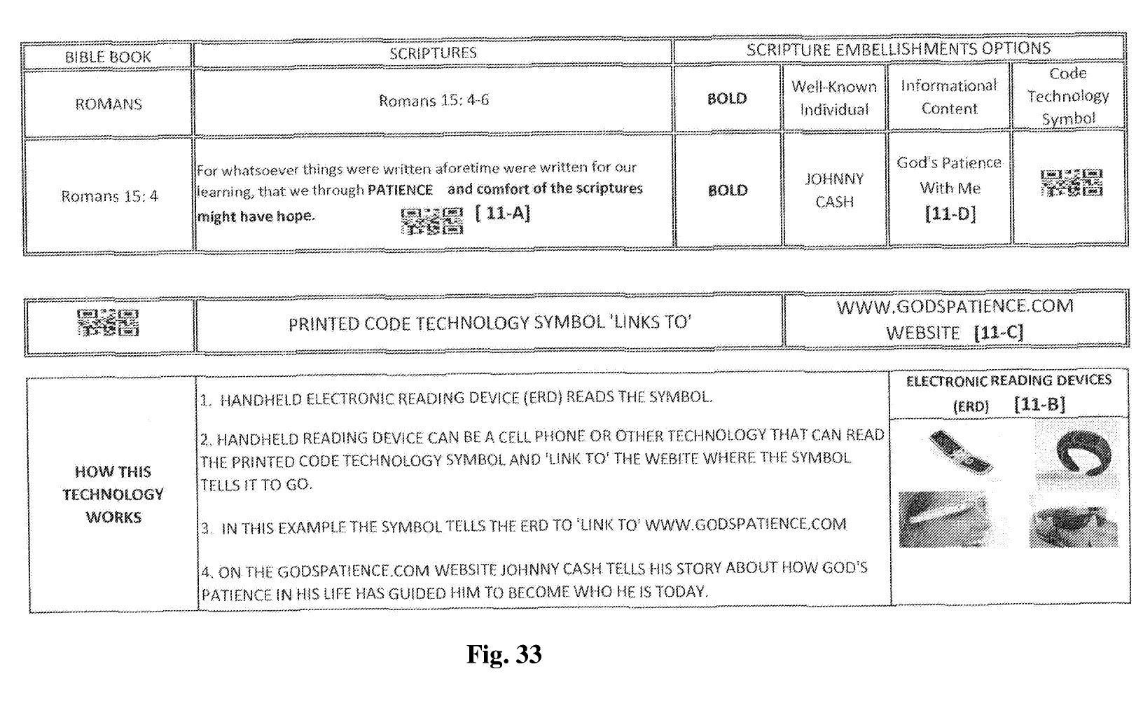

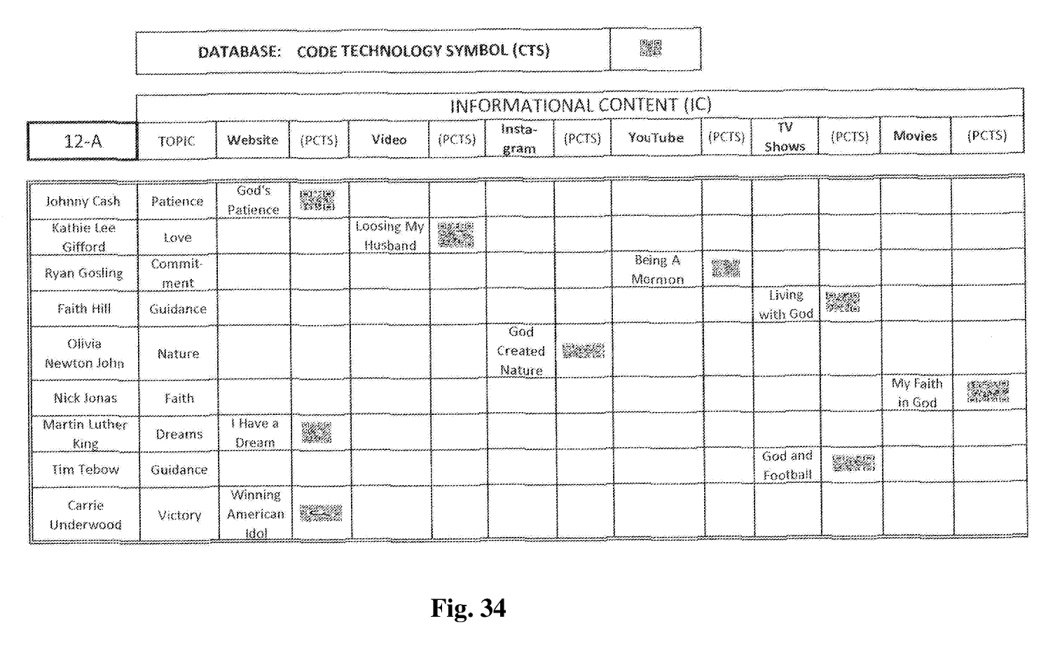

Referring to FIG. 17, when the inventive book 10 is put in the position of FIG. 14, and opened, it reveals a second text, in this case a religious text such as the Bible or other religious text as detailed above. This text may take the form of a chapter of the Bible reflected by print 36 and text 38, some of which may be in bold (or highlighted in other ways, for example by color printing or by yellow highlighting) as illustrated by text 40 in accordance with the teachings of the invention relating to highlighting text, as detailed above.

Referring back to FIG. 16, biographical side 14 tells the story of an individual whose personal faith in their Higher Power has helped them during their lifetime. It also references and/or incorporates and/or explains the scriptural and foundational text, such as the Bible. These individuals are preferably be chosen from the ranks of the famous to emphasize the positive effects of religion. Prominent examples could include: Oprah Winfrey, Jimmy Carter, and Princess Diana. Alternatively they may be real-life everyday heroes, such as firefighters, or fictional characters whose experiences embody real-life triumphs and hardships. See FIGS. 18-21. Their spiritual path and faith would be outlined in what is known as the individual's Spiritual Life Cycle, which creates the basic outline for their story. No one person is born into this world with faith. Faith is acquired as a result of the many different occurrences that have happened in that person's life. This is how people come to have spiritual faith.

Thus, the end result is that every individual encounters several different Spiritual Life Cycles during their lifetime.

Spiritual Life Cycles may be times of extreme spiritual closeness to a higher power or times when one feels that their higher power has totally abandoned them. The resulting ebb and flow of faith in an individual's life will provide the foundation for the story that will be told in the biographical side 14.

Referring to FIG. 17, on the reverse side of the book 10 is the coordinating scriptural and foundational text 18, which is detailed and dissected in correlation with biographical part 14. A Christian coordinating scriptural and foundational text would be the Holy Bible, while a Jewish coordinating scriptural and foundational text might be the Torah. These would be chosen so that religious text 18 matches the faith of the individual whose story is told in biographical part 14.

The design of this invention is unique in that the scriptural and foundational text 18 is presented on one side, and, when the volume is “flipped over”, the biographical side 14 tells the story of the individual whose faith in that corresponding religion has guided them during their life, thus creating a single book 10 bound together by spine 22 as shown in FIGS. 13 and 14.

These books will incorporate the personal testimonies of individuals who provide inspiration to, serve as mentors for, and whose own personal testimonies assure believers and non-believers, that their individual faith and commitment to God and/or their higher power has guided them to become the person they are today. This Spiritual Life Cycle of an individual's life provides the format through which biographical part 14 can be tied to scriptural and foundational text 18.

Different translations for the corresponding religion can be used for each book as they apply to the story which is related in biographical part 14.

Because the scholars and publishers of scriptural and foundational texts of religions have focused on copyrighting their specific translations, the present invention can potentially use any available translation that related to the individual whose Spiritual Life Cycle in detailed. Thus, if a person prefers one translation over another the publisher would only need to secure the printing rights to use the translation of choice as the scriptural part 18, which will in turn be matched up to biographical part 14.

The biographical work 14 and corresponding scriptural and foundational text 18 will form one book 10. As an individual writes the story about their life in accordance with the method of the present invention, they are able to identify periods of time in their life when different things that occurred seemed to have the same or similar underlying themes. These identified periods of time are grouped together under headings that best describe what the writer was encountering personally. Subject headings could be pain, joy, anger, frustration, serenity and so forth. Once the different subject headings are chosen, selections from the writer's religion will be paired to match. These selections form the scriptural and foundational text 18. The chosen scripture are identified under the subject heading and intertwined with the written story, either on the sides, top, or bottom of the page, or within the story itself. Pertinent chosen scripture 18, intertwined in the same book 10 as the biographical story 14, allow the reader to understand how scripture can relate to everyday occurrences.

The reader's comprehension of the scriptural and foundational text 18 may be slow at first, however as the reader proceeds through the biographical side 14 they begin to understand how it illuminates the scriptural side 18 and how both can be relevant to their own life. Each book describing a Spiritual Life Cycle in the biographical part 14 of the well-known individual will show corresponding related examples of religious text in the scriptural and foundational text 18, making the ancient and obscure more easily understandable.

The primary benefit of this incorporation of religious text 18 into religious book 10 is that it illuminates in a single volume not just the words but the underlying principles as well. Moreover, the two documents may be viewed in a conventional manner and easily accessed individually without having to look to where the second document begins. This is especially helpful in the case of two related stories or two related content sets as are envisioned here.

Given the radically different nature of the contents, each book receives equal billing on its associated side of the volume. This may be of some importance to an individual reading the book and public whom may prefer to be seen reading one book but not the other. It is also a way of giving evil dignity to both works, which improves the likelihood that they will both be viewed as of equal relevance and importance. This is particularly valuable in the case of, for example, a scriptural text and a contemporary story, where the relevance of the contemporary story to today's world might otherwise be seen to overshadow and make minimally important the relevance of the scriptural work, thus lessening the impact of the scriptural work.

Moreover, the use of a contemporary story and a scriptural work in one volume may result in the book being carried, for example, to work and being read while an individual is using public transportation. More particularly, it may be taken as reading material on account of its contemporary content, but should the reader complete the contemporary part of the book in the middle of a, for example, bus ride, there is extremely high likelihood that the individual will begin to read the scriptural work.

In accordance with the present invention, it is further contemplated that the scriptural work has cross references to the contemporary work. For example, in a book which has the story of, for example, Oprah Winfrey on its obverse, the story of Oprah Winfrey whether biographical or autobiographical, would have numerous references to biblical text. All of the parts of the biblical text referred to in the biographical or autobiographical portion of the work may also in turn, be marked, optionally, with the page reference to the biography or autobiography section which discusses it. In addition, footnotes, color printed sections, highlighted sections, large type sections or the like in the biblical text may be included with or without reference to sections of the biography of Oprah Winfrey.

In accordance of the present invention, it is contemplated that the text of the scriptural text may be used to summarize paraphrase or otherwise illuminate the biblical text on the basis of the experience of the individual whose story is told in the biographical or autobiographical section.

By pairing the scriptural and foundational text 18 with biographical side 14 and cross-referencing the pages of the two, the present invention facilitates the comprehension of the deeper meanings a religious text may contain. As compared with a conventional Bible or Qur'an this invention embodies a modern approach, relating the lessons and stories of that original text to the life of a celebrated member of society. The combination and cross-referencing of the texts in a single volume in fundamental to the success of the educational aspect. A biography and a religious text apart from one another provide none of the illumination which these texts would. The difference is that the publisher has done the work of unearthing the connections between the two.

Although the present invention has been described in accordance with the embodiments, the embodiments and variations would be within the spirit and scope of the present invention. Accordingly, many modifications may be made by one of ordinary skill in the art without departing from the spirit and scope of the invention. For purposes of this Invention we define Bible as the Christian Holy Bible.

For purposes of this Invention we define Foundational Religious Text as the lessons, sacred stories, scriptures, spiritual knowledge, teachings, tenets and translations that followers of a religion read and study, to become knowledgeable about the beliefs and teachings of that religion. (Examples: Bhagavad Gita for Hindu text, Buddhavaca for Buddhist text, Torah for Jewish text, Koran for Muslim text and so forth).

For purposes of this Invention we define Book Creator as the individual developing and creating a Customized Bible and/or Customized Foundational Religious Text.

For purposes of this Invention we define the Book Development Platform (BDP) as the place where Book Creators go to develop Customized Bibles and Customized Foundational Religious Texts, using the features and elements taught in this and prior patent applications. The Book Development Platform further affords Book Creators the opportunity to sell the books they have created to consumers around the world. For purposes of this Invention we define Informational Content (IC) as information a Book Creator can select to be included in any Customized Bible and Customized Foundational Religious Text they develop. Informational Content (IC) refers to the content that the Book Creator, associates with selected scriptures, to provide additional teachings related to the selected scriptures. The Informational Content (IC) sources for these teachings comes from: websites, videos, Instagram images, SnapChat, Twitter postings, television shows, movies and other sources that have yet to be identified.

For purposes of this Invention we define the Code Technology Symbol (CTS) as the symbol (example: QR-Code) that ‘links to’ the Informational Content (IC). The Code Technology Symbol (CTS) is placed by the scriptures the Book Creator seeks to provide further teachings on. The Code Technology Symbol (CTS) identifies and links the reader to a site that provides further teachings, which are subsequently read, viewed, and listed to on an Electronic Reading Device (ERD).

For purposes of this Invention we define Electronic Reading Device (ERD) as the device that a Reader uses to scan the Code Technology Symbol (CTS) located by the scriptures that the Book Creator has selected to ‘Link To’ the Informational Content (IC) chosen by the Book Creator, while developing the Customized Bible or Customized Foundational Religious Text.

The purpose of placing a Code Technology Symbol (CTS) by selected scriptures in the Customized Bible and Customized Foundational Religious Text is to facilitate continued learning by the Reader. The Electronic Reading Device (ERD) reads the Computer Technology Symbol (CTS) which links the Reader to the Informational Content (IC) synchronizing a print, visual and audio learning experience.

Due to the unique nuances and weight of the papers used for the manufacture of many Faith Based and Religious Books that contain the lessons, sacred stories, scriptures, spiritual knowledge, teachings, tenets and translations of many religions, these Customized Bibles and/or Customized Foundational Religious Texts is unique and differs from other book customization approaches. The papers used require manufacturing processes that Inventor, Ms. Andres has previously defined and taught, relative to the design and manufacture of Customized Bibles and Customized Foundational Religious Texts.

We have identified, tested and defined specific Lightweight Papers capable of being used in printing that will facilitate the manufacture of Custom Printed Bible and Custom Printed Foundational Religious Text.

We have identified, tested and defined the type of printing process required to manufacture these Customized Bibles and Customized Foundational Religious Texts as Ink-Jet Printing.

We have identified, tested and defined that On-Demand Variable-Data Printing using ink-jet print technology is desirable for the manufacture of Custom Printed Bibles and Custom Printed Foundational Religious Texts.

We have identified, tested, and determined that the manufacture of Customized Bibles on lightweight papers, using on-demand variable-data print technologies with ink-jet printing is achievable. These identified technologies allow lightweight papers to be printed, the paper signatures to be bound into book format, the book format to be bound with a cover and the finished book delivered to the customer, fulfilling the customization criteria of the Book Creator who developed a Customized Bible or Customized Foundational Religious Text on the Book Development Platform (BDP).

It is important to note that while the Book Creator may or may not be the final recipient of the completed and Customized Bible or Customized Foundational Religious Text. The Book Creator may have developed a Customized Bible or Customized Foundational Religious Text for a specific person, to share specific scriptures that will bring ‘special meaning’ to the recipient of a Customized Bible or Customized Foundational Religious Text.

Additionally, the Book Creator may choose to develop a Customized Bible and/or Customized Foundational Religious Text to be sold to consumers who visits the Book Development Platform (BDP).

We have identified, tested and defined the necessary procedures required for the development and manufacture of Customized Bibles and Customized Foundational Religious Texts that will meet the spiritual, educational, and prescribed development elements sought by, offered to, and chosen by a Book Creator seeking to develop a Customized Bible and/or Customized Foundational Religious Text for themselves, for others, or to be sold on a Book Development Platform (BDP).

We have identified, defined and describe that Book Creators shall always begin their customization process by selecting the Religion. Subsequently they will select lessons, sacred stories, scriptures, spiritual knowledge, teachings, tenets and translation of the Bible or selected Foundational Religious Text of the Book Creator's choosing. The selected works serve as the foundation of any Customized Bible or Customized Foundational Religious Text that will be developed on a Book Development Platform (BDP).

This invention and the teachings differ from other book development platforms because all customized books developed on our Book Development Platform (BDP) begins with a selection of a Religion and/or Faith. Next, the lessons, sacred stories, scriptures, spiritual knowledge, teachings, tenets and translations that provide the scriptural, spiritual and religious foundation of the chosen religion and/or faith are selected.

We have identified, tested and defined that the elements and features taught in this Invention do not change the time-honored lessons, sacred stories, scriptures, spiritual knowledge, teachings, tenets and translations found in a Bible and/or Foundational Religious Text. Instead, we define that these new technologies will teach Book Creators how they can enhance scriptures and increase scriptural comprehension in a Customized Bible or Customized Foundational Religious Text.

These improvements serve to expand a Reader's comprehension of scripture.

We have identified, tested and defined the customization elements and features presented to the Book Creator, who makes their selections. The finished book, that has selected elements included will provide the Reader with the opportunity to read Scriptures from a Customized Bible and Customized Foundational Religious Text.

Concurrently, the Reader is being taught greater comprehension and meaning of the time-honored lessons, sacred stories, scriptures, spiritual knowledge, teachings, tenets and translations in a new, modern, engaging and contemporary manner. We believe these new and improved technologies will allow Readers to become personally engaged with Scripture.

We have identified, defined and describe the necessary procedures that allow a Book Creator to include stories from well-known individuals, whose Spiritual Life Cycle and whose own personal faith and commitment to their God has guided to become the people they are today. We believe these stories included alongside scriptures contained in a Customized Bible and Customized Foundational Religious Text will significantly increase scriptural comprehension and understanding of scriptures for our Readers.

In this Continuation Patent, we identify and define new and improved technologies for a “Method for Teaching Individuals About the Comprehension of Religious Texts by Synchronizing Contemporaneous Print, Visual and Audio Learning Opportunities”. Studies show that when information being taught is delivered with multiple learning styles, comprehension of the subject-matter increases dramatically. These new. improved and synchronized learning technologies will continue to teach and aid scriptural comprehension in innovative ways. This synchronized learning system can deliver scriptural comprehension to Readers of all ages, faiths and religious beliefs throughout the world through a Customized Bible or Customized Foundational Text developed on our Book Development Platform (BDP). We seek to increase the Scriptural Comprehension of the lessons, sacred stories, sacred stories, scriptures, spiritual knowledge, teachings, tenets and translations of all religions and faiths with these new technologies.

One Critically Important Factor to Note: In 2001 when the first patent application for these inventions was filed, the printing technology that would dominate the on-demand variable-data printing industry had yet to be defined. At that time, both laser printing and ink-jet printing were the two print technologies emerging in the new and developing on-demand variable-data print category. Due to the newness of the on-demand variable-data print technologies, neither laser printing nor ink-jet printing had yet emerged as the dominant print technology in the printing industry.

In the initial and subsequent Patent Application filings, Inventor Ms. Kathleen Andres, selected Ink-Jet Print technology as the print technology to be used to produce Customized Bibles and Customized Foundational Religious Texts. This decision was made after testing had been completed. It was determined that the lightweight qualities of the papers, coupled with the ink distribution variables that ink-jet print technology allows, was the correct choice for on-demand variable-data print technologies on lightweight papers.

This decision was supported by the known fact that on-demand variable-data ink-jet print technology had a consumable revenue stream (ie. Ink sold to printing companies). It was predicted that research and development funds would be invested in ink-jet print technology by the companies inventing and manufacturing the new variable-data on-demand printing presses. This assumption was correct. Today, Ink-Jet Printing is the dominant print technology for on-demand variable-data printing in the Printing Industry.

The “Method for Imbuing Individuals with Religious Faith by Combining Scriptural and Biographical Readings” as described in U.S. patent application Ser. No. 11/528,744 filed on Sep. 28, 2006 teaches and defines a method and resulting product for printing a Bible, Torah or other Foundational Religious Text personalized to an intended recipient.

The invention further teaches and defines how a person creating a Customized Bible or Customized Foundational Religious Text can select a characterization of the Bible, the age group of the reader, a list of problems of the reader and subsequently is given the opportunity to select relevant scripture and sacred texts to be highlighted in the finished product.

The Spiritual Life Cycles of individuals create the basic outline for the story. No one person is born into this world with faith. Faith is acquired from many different occurrences that have happened in a person's life. This is how people come to have Spiritual Faith.

The books developed using this development system “Incorporate the personal testimonies of individuals who provide inspiration to, serve as mentors for, and whose own personal testimonies assure believers and non-believers, that their individual faith and commitment to God and/or their Higher Power has guided them to become the person they are Today®.

These methodologies further define additional teachings and features available to create Customized Bibles and Customized Foundational Religious Texts, by the combining of scriptural and biographical readings. These technologies, features and elements have been taught in the prior patent applications.

New technologies and new improvements described herein have been developed for “Method for Teaching Individuals to Comprehend Religious Texts by Synchronizing Contemporaneous Print, Visual and Audio Learning Opportunities”. These synchronized technologies offer new improvements to technologies previously disclosed, while expanding on the learning capabilities developed and taught in prior inventions and patent applications.

These new technologies define new elements and features that will improve the way stories of well-known individuals are shared in Customized Bibles and Customized Foundational Religious Texts. Readers and Book Creators using an online book development platform (BDP) will gain insight into scriptures through the aligning of print, visual and audio viewed as a synchronized technological element.

The book development platform (BDP) will contain both public domain and copywritten translations of the Bible and other Foundational Religious Texts that the Book Creator may choose from as the foundation of the book being customized. The lessons, sacred stories, scriptures, spiritual knowledge, teachings, tenets and translations for each faith and religion serve as the spiritual foundation of these Customized Bibles and Customized Foundational Religious Texts. It is from these lessons, sacred stories, scriptures, spiritual knowledge, teachings, tenets and translations that all Customized Bibles and Customized Foundational Religious Text will be created.

This invention further teaches a process for distributing Informational Content (IC) from the printed pages of a Customized Bible or Customized Foundational Religious Text where an Electronic Reading Device (ERD) enables the information to be read, viewed and listened to. Readers who use this synchronized print, visual and audio technology will gain increased scriptural knowledge and insight resultant of the multi technology synchronized learning opportunity presented.

Book Creators will select scriptures and identify the meanings, as they understand them to be. The selected scriptures will inspire the informational content (IC) that will be selected for the reader to “Link To” on an electronic reading device (ERD). The informational content (IC) selected can be about a person, place, event. Or the informational content (IC) can simply ‘support the teachings of’ and ‘bring greater meaning to’ the selected scriptures the Informational Content (IC) relates to; while being read by the Reader.

The teachings in this invention will permit Book Creators to select specific scriptures to enhance by linking informational content (IC) to an electronic reading device (ERD); with the Code Technology System (CTS) being printed by the selected scriptures. In addition, stories can be included about individuals whose personal faith in their Higher Power has helped them and guided them during their life.

These stories of well-known individuals will be inserted by relevant scriptures. There can also be a ‘link to’ selected informational content (IC) that further shares a visual and audio lesson taught about the selected scriptures. The ‘linking’ from the printed page to the chosen informational content (IC) that goes to the electronic reading device (ERD) is accomplished by a Code Technology Symbol (CTS) printed on the page, by the selected scriptures.

The Informational Content (IC) sources for these teachings will come from: websites of well-known individuals, videos, Instagram images, SnapChat, Twitter postings, television shows, movies and other sources that have yet to be identified. The informational content (IC) will be a constant source of updated information that Book Creators, can tap into, while creating their Customized Bible and Customized Foundational Religious Text books.

Each informational content (IC) link will be identified by its own unique Code Technology Symbol (CTS) that is specific to the corresponding Informational Content's (IC) online location. An example of a code technology symbol that exists today is the QR-Code.

Upon seeing an informational content (IC) link on the page of a Customized Bible or Customized Foundational Religious Text, the Reader will use their electronic reading device (ERD), which could be a SmartPhone, Google Glass, or other electronic reading device (ERD) yet to be presented, that will ‘read the Code Technology Symbol (CTS) and link the reader to the online location of the corresponding informational content (IC).

Each Informational Content (IC) selection will be associated with its own unique Code Technology Symbol (CTS) inserted, on the printed pages of the Customized Bible or Customized Foundational Religious Texts, by the scriptures being taught. Each Informational Content (IC) selection will support the teachings of the selected scriptures and often share scriptural knowledge of the well-known individuals, places, events and others, as identified.

This interactive “Method for Teaching Individuals to Comprehend Religious Texts by Synchronizing Contemporaneous Print, Visual and Audio Learning Opportunities” will be a feature offered on the book development platform (BDP) established specifically for creation of Customized Bibles and Customized Foundational Religious Texts.

The book development platform (BDP) can be both a stand-alone online Book Development Platform (BDP) OR a “Private Label” book development platform (BDP) integrated into the website of a religious publisher, religious organization and other entities seeking to increase scriptural comprehension, knowledge and teachings. This Book Development Platform (BDP), plus the elements presented and taught for the creation of Customized Bibles and Customized Foundational Religious Texts, are unique to today's Customized Book Development Sites such as Blurb, Ingram Spark, and Lulu books.

Studies show that: 70% of Teens State They Prefer To Read the Holy Bible in PRINT FORMAT. (“2016 Teen State of the Bible Research”—barna.org). Our New and improved technologies that integrate and synchronize print, visual and audio multi-technology features reinforce the importance of developing new technologies that will assist individuals developing Customized Bibles and Customized Foundational Religious Texts. Book Creators seeking to increase their own personal scriptural comprehension in the religion of their choosing or multiple-religions will use our Book Development Platform (BDP) to create a personal and customized book that addresses their religious and faith-worthy beliefs.

Teens state that their most common interactions with the Holy Bible occur when: Hearing scripture in a worship service or Mass (87%), reading it from a print version of the Bible (70%), attending a Bible study (50%); reading Bible content on the Internet (35%), and from using a Bible App on their SmartPhones (33%). (“2016 Teen State of the Bible Research”—barna.org). 70% (seventy percent) of the 227 million people in the United States identify as Christians. This equates to 159 Million Christians residing in the United States. 2016 studies show that 75 Million people claim to read the Holy Bible once a week, which breaks down to: 49% of Elders, 25% of Teens, and 24% of Millennials. (“Bible in America—6 Year Trends”—barna.org).

Despite these staggering statistics relative to the high numbers of Christians who regularly read and engage in their Holy Bibles—Adherents, Book Creators, Readers, and Religious Leaders do not possess the ability to develop a Customized Bible or Customized Foundational Religious Text. The Customization technologies taught, described and defined in this and prior patent applications, developed by Inventor Ms. Kathleen Andres, will allow people of all Faiths and Religions the opportunity to develop Customized Bibles and Customized Foundational Religious Texts. These Customized Bibles and Customized Foundational Religious Texts will bring greater meaning to the most holy of lessons, sacred stories, scriptures, spiritual knowledge, teachings, tenets and translations Readers will read, study and embrace in their daily spiritual growth.

Could the ability to develop Customized Bibles and Customized Foundational Religious Texts not exist to date because the relatively small number of translation owners who publish Bibles for 6.0 Billion Adherents do not seek change? We think not. Rather we believe that Translation owners are not typically the printing companies who print these books. And the printing companies who do print these books routinely require minimum print runs, of any one book printed and published, from Religious Publishers.

The requested minimum print run quantities of each books printed keeps the printing presses running and manufacturing books for the 6.0 Billion Adherents worldwide. Printing a book on lightweight papers is a specialized segment of the book printing business. Special printing presses are required.

What would incent any printing company, selling to the lucrative Religious Publishing Industry, seek to change the existing business model; while potentially disrupting this business model and eroding a lucrative revenue stream? Answer: These printing companies do not appear to have sought out change in the printing methods offered to the Religious Publishing Industry. This is a non-issue from the perspective of the printing companies who print for the religious publishing industry, as change may cannibalize the profits earned from this segment of the printing industry.

The world has changed. Adherents who rely on the lessons, sacred stories, scriptures, spiritual knowledge, teachings, tenets and translations of their religion need to be given the opportunity to develop their own Customized Bible and Customized Foundational Religious Text. Plus, normal everyday individuals, should be allowed to share their insights on their faith with others. Today, opportunities like this simply do not exist. The inventions and patent applications of Inventor, Ms. Kathleen Andres, provide the patented technologies required to bring change to the religious printing and the Religious Publishing Industry.

As complicated and complex as car manufacturing is, a consumer can purchase a customized car, made to their specifications via an online Car Manufacturing Development Platform. One need only go to websites such as: Autobytel.com, Bmwusa.com, Edmunds.com, and Mercedesbenz.com to purchase a customized automobile. Still, the Best-Selling Book in the World, The Holy Bible, is unable to be purchased as a Customized Bible.

Members of the religious publishing industry have used ‘New Translations’ as the SOLE means of developing ‘New, Contemporary and Updated Scriptures’ for the BILLIONS of Adherents worldwide. This is something they do very well. These new and improved translations afford Adherents, Everyday People, and Readers the opportunity to better comprehend scriptures. Now, for the first-time ever, these new innovations, technologies, elements, and features will allow individuals who want to develop a Customized Bible or Customized Foundational Religious Text to do exactly that.

Customized Bibles and Customized Foundational Religious Texts developed by Adherents, Book Creators, Everyday People and Readers will be sold on our Book Development Platform (BDP). These books will allow individuals the opportunity to purchase books that provide increased comprehension and understanding of the lessons, sacred stories, scriptures, spiritual knowledge, teachings, tenets and translations contained in these time-honored scriptures.

The book development platform (BDP) presents new elements, features, innovations and synchronized technologies for the development of Customized Bibles and Customized Foundational Religious Texts, that will bring increased meaning to the lessons, sacred stories, scriptures, spiritual knowledge, teachings, tenets and translations of all religions. These teachings coupled with the many well-established and read lessons, sacred stories, scriptures, spiritual knowledge, teachings, tenets and translations of all religions and faiths, will bring religious comprehension, learning and understanding to millions of individuals seeking religious understanding worldwide. This is our goal! Inventor, Kathleen Andres, has confidence that Adherents, Book Creators, Everyday People, and Readers thirsting for scriptural understanding will quickly embrace having the opportunity to develop Customized Bibles and Customized Foundational Religious Texts. Just as Customized Burger King Hamburgers increased sales, we acknowledge that sales of Customized Bibles and Customized Foundational Religious Texts will exceed expectations.

The new and improved technologies that synchronize print, visual and audio synchronized learning will be employed by Book Creators developing Customized Bibles and Customized Foundational Religious Texts. These technologies will coincide with the media obsessed society in which we live. Readers will be offered the opportunity to engage in print, visual and audio learning, in a synchronized manner.

Studies show that integrating multiple teaching styles greatly increases comprehension and retention of the subject matter. In this case, the knowledge and understanding of scriptures will be greatly increased. And as noted earlier, the Religious Publishing Industry has repeatedly viewed the development of New Translations, as the sole method used to bring ‘modern scriptural comprehension’ to Billions of Adherents and Believers.

Ms. Kathleen Andres, the inventor of these new and innovative book development technologies understands that synchronized print, visual and audio learning opportunities, on a book development platform (BDP), will aid to further increase scriptural comprehension. We intend to offer these Technologies on our book development platform (BDP) to the 84% of the global populace who claim to Believe in God which equates to roughly 6.2 Billion Potential Customers of Global Believers. (Washington Times, Dec. 23, 2012).

We see no better way to enter the lucrative Religious Publishing Industry, than through the development of a Book Development Platforms (BDP) that integrates and employs new and improved technologies taught in this and prior patent applications. These customized book development technologies taught in each utility patent over an extended period, have taught and described ‘foundational stepping stones’ to the new and improved technologies defined within.

Not since Johannes Gutenberg first printed the Holy Bible with movable type in 1454 or 1455 has the printing production of the Holy Bible changed . . . Until Now. We believe the teachings, elements, features, inventions, technologies and information detained in each patent application clearly define new and innovative printing and book development technologies that will forever transformation the rudimentary mechanics of the development and printing of Holy Bibles and other Foundational Religious Texts.

Our Book Development Platform, coupled with stated elements, features. Teaching and technologies will align Adherents, Believers, Book Creators, and Individuals of religions and Faiths to develop and print Customized Bibles and Customized Foundational Religious Texts.

We trust that these combined innovations will revolutionize and disrupt the status-quo of the religious printing and religious publishing industry. Any person of normal intelligence, wishing to share their religious beliefs, teach others about their faith, while bringing greater understanding and comprehension to the scriptures will now be afforded this special opportunity through the development of Customized Bibles and/or Customized Foundational Religious Texts. Adherents, Book Creators, Individuals, Everyday People, Pastors, Imams, Rabbis, Religious Leaders, Seekers, and Readers of religious lessons, sacred stories, scriptures, spiritual knowledge, teachings, tenets and translations will benefit from these new technologies. The biographical readings relative to Spiritual Life Cycles will greatly aid Readers to understand these time-honored scriptures.

IN CLOSING: These discoveries, teaching, new technologies and inventive processes that have been taught, to be used to develop Customized Bibles and/or Customized Foundational Religious Texts on a Book Development Platforms developed in multiple different categories. The Book Development Platform (BDP) can be developed to teach the lessons, sacred stories, scriptures, spiritual knowledge, teachings, tenets and translations for: One Faith, One Religion OR Multiple Faiths and Multiple Religions.

This and prior patent applications and inventions, define the teachings, technologies and plans that represent Version 2.0 of the Religious Printing and Religious Publishing Industry. In Version 2.0 of the Religious Printing Industry and Religious Publishing Industry, New Translations no longer represent the sole means of introducing New Bibles and New Foundational Religious Texts to Adherents.

Our many patent applications define, teach, introduce and instruct new and improved techniques to clarify the lessons, sacred stories, scriptures, spiritual knowledge, teachings, tenets and translations of all faiths and religions; while employing new and improved print technologies; that will further create new Religious Publishers to the religious publishing industry.

Just a few of the reasons we have named our books: Customized Bibles and Customized Foundational Religious Texts.

How These New & Innovative Technologies Work:

1) Book Creator seeking to develop a Customized Bible or Customized Foundational Religious Text will visit the Book Development Platform (BDP). (FIG. 1)

2) Next the Book Creator will select the Religion they want to create a book for. (FIG. 2)

3) Next the Book Creator will select the Book of the Religion that corresponds with the teachings and scriptures of the chosen Religion, they want to develop into a Customized Bible and foot Customized Foundational Religious Text. (Example: Christian Religion is selected. Next the Holy Bible is selected). (FIG. 3)

4) Next the Book Creator select the Translation of the Book. If there are no Translation choices the Book creator is informed of this. (FIG. 4)

5 A) Next the Book Creator will select the Scriptures. In this Step the Book Creator selects the Scripture(s) they want to customize. (FIG. 5-A)

5 B) Next the Book Creator selects the manner that the selected scriptures will be Embellished and which embellishment will be use on each Scripture. Examples of the embellishments chosen scriptures can possess include: highlight, bold, underline, and choose text colors, to name a few but not all customization features. (FIG. 5-B)

6) Next the Book Creator is given the opportunity to Include information about a well-known individual into the printed text of the Customized Bible, being developed. (As taught in Continuation patent application Ser. No. 11/528,744). (FIG. 6)

7) Next the Book Creator Searches in the Informational Content (IC) database located in the book development platform (BDP) on a Topic, Person, Subject or other defined information that the Book Creator believes to be relevant to the selected Scriptures they have selected. (FIG. 7)

8) Next the Book Creator using the Customized Book Development Platform (BDP) will contain a database of online Informational Content (IC), each with a unique and corresponding Code Technology Symbol (CTS), that can be inserted onto the printed pages, in the selected location, selected by the Book Creator of a when the Customized Bible or Customized Foundational Religious Text. (FIG. 8)

9) Each Informational Content (IC) element contained in the book development platform (BDP) database available for insertion into the Customized Bible and Customized Foundational Religious Text being created, is identified by its own unique Code Technology Symbol (CTS). [Example of Code Technology Symbol (CTS) is a QR-Code]. (FIG. 9)

10) The Book Creator inserts the Code Technology Symbol (CTS) that is unique to and related to the linked information, by the scripture they have selected. (FIG. 10)

11) The Code Technology Symbol (CTS) placement on the printed page, by the selected scripture, will allow the Reader of the Customized Bible and/or Customized Foundational Religious Text ‘to link to the Informational Content (IC)” the Book Creator has selected, to instill greater understanding to the selected scriptures. (FIG. 11)

12) When the printed Customized Bible and Customized Foundational Religious Text is being read, the code technology symbol (CTS) allows the book reader to ‘link to’ the chosen Informational Content (IC) by using an electronic reading device. (FIG. 11-A)

13) The electronic reading device (ERD) is an imaging device reads, interprets, and

links the code technology symbol (CTS) to the online web address associated with the code technology symbol (CTS). (FIG. 11-B)

14) The electronic reading device (ERD) of the code technology symbol (CTS) would be a hand-held or any device that is worn with imaging capabilities such as a cell phone, pen, Google Glass or other reading device with these capabilities. (FIG. 11-B)

15) The Informational Content (IC) selected by the Book Creator will most probably have been chosen, to bring greater understanding of the scriptures, to the Reader of the Customized Bible and Customized Foundational Religious Text. (FIG. 11-C)

16) The selection and placement on the printed pages of the Customized Bible for each code technology symbol (CTS) will be where the linked Informational Content (IC) teaches a lesson or thought related to the selected scriptures. (FIG. 11-D)

17) The database of code technology symbols (CTS) the Book Creators can select from will be extensive and include online Informational Content (IC) from a variety of different sources. (FIG. 12)

18) The Informational Content (IC) available in the code technology symbol (CTS)

database might include: YouTube sermons, well-known individuals presenting public speaking dialogs on specific topics, Podcast on a topic that relates to the selected scripture, Printed teaching about the scriptures identified, a television show or movie with a relevant message, and so forth. (FIG. 12-A)

19) Billions of people around the world will have access to this online Customized Bible and Customized Foundational Religious Text Book Development Platform (BDP). For exemplary purposes, we have named the book development platform (BDP) MicahProject.com; named after the Prophet Micah who felt he had been called by God to share God's word with the masses. (FIG. 12-B)

20) As everyday individuals create their own Customized Bible and Customized Foundational Religious Text, MicahProject.com will allow Book Creators to sell the customized religious books that they have created. We believe that the MicahProject.com book development platform (BDP) will increase the comprehension of religious scriptures, as everyday people develop Customized Bibles and Customized Foundational Religious Texts, while sharing their knowledge of scripture with others. (FIG. 12-B)

21) Once the Book Creator has:

### a) Selected the Religion;

### b) Selected the Book to be Customized;

c) Selected the Translation (if a choice is available);
d) Selected the Scriptures to be embellished;
e) Selected which embellishments go with which Scripture;
f) Selected the Story of a Well-Known Person to be included by chosen Selected Scriptures;
g) Selected the scriptures where the corresponding code technology symbol (BTS) will be included;
h) Selected the Informational Content (IC) that will be placed by the selected scriptures;
i) The Book Creator will be able to review the embellishments made to their Customized Bible or Customized Foundational Religious Text on the book development platform (BDP);
j) After the Book Creator, has reviewed their customization features, stories and Information Content (IC) added to their customized book;
k) The book will be submitted to be printed, as created by the Book Creator;
l) The customized book will be printed using on-demand variable-data ink-jet print technologies taught in earlier related patent applications and inventions.

Prior Patent Applications teach the systems, technique, features and elements that will allow Book Creators to develop, create, and print Customized Bibles and Customized Foundational Religious Texts. These teachings define ways to embellish, enhance and bring greater meaning to scriptures; while including the Spiritual Life Cycle teachings of a well-known individual. Spiritual Life Cycles create stories and scriptural teachings relative to the Bible and other Foundational Religious Texts.

Still, one of normal intelligence, must understand that the creation of any Customized Bible or Customized Foundational Religious Text, always begins with the selection of the RELIGION. Once the Religion has been selected, the BOOK to be customized and the corresponding TRANSLATION are then selected.

An example for Christians designing a Customized Bible would be the religious lessons, sacred stories, scriptures, spiritual knowledge, teachings, tenets available in the Holy Bible; with available Translations being: American Standard Version, Good News, King James, New International Version, and New King James. Once the religious scriptural translation is selected the book can be further customized using elements, features, technologies and claims taught in this earlier patent applications and inventions.

The creation of this innovative book development platform, with its numerous features offers Book Creators the ability to develop Customized Bible and Foundational Religious Texts, while introducing a new business model to the closely held and tightly controlled Religious Publishing Industry.

Over 84% (eighty-four percent) of the global population claim to possess faith, it is completely understood that this segment of the publishing industry represents a lucrative and profitable business opportunity that claims over 6 Billion potential customers. (Washington Times, Dec. 23, 2012).

This Continuation Patent continues to teach new innovations and technologies that will be afforded to Book Creators using a book development platform (BDP) used to bring greater comprehension of scriptures to people throughout the world. Customized Bibles and Customized Foundational Religious Texts, with these new technologies will integrate print, visual and audio technologies into scripture, while including stories from the Spiritual Life Cycle of well-known individuals, as taught in this

1. A method of educating and instilling moral values in an individual, comprising:
creating a first set of pages having content selected from a classical philosophical text;
creating a second set of pages having content selected from a life experience story of an individual or individuals who may serve as a role model, said content selected from a life experience story of said individual or individuals including information reference to said classical philosophical text;
associating said first set of pages to said second set of pages to form a volume;
providing said volume to said individual.

2. A method as in claim 1, wherein said first and second sets of pages are bound into a book with two covers, and with orientations such that said first set of pages comprises a first cover oriented in a conventional manner when said book is positioned with said first cover exposed, and said second set of pages comprises a second cover oriented in said conventional manner when said book is positioned with said second cover exposed.

3. A method as in claim 2, wherein said philosophical text is the Bible.

4. A method as in claim 1, wherein said classical close optical text is annotated with references to said content from a life experience story.

5. A method as in claim 1, wherein said volume is printed with substantially flat ink on lightweight paper.

6. A method as in claim 1, wherein said first and second sets of pages are bound into a book with two covers, and with orientations such that said first set of pages comprises a first cover oriented in a conventional manner when said book is positioned with said first cover exposed, and said second set of pages comprises a second cover oriented in said conventional manner when said book is positioned with said second cover exposed, said philosophical text is the Bible and said volume is printed with substantially flat ink on lightweight paper.

7. (canceled)

8. (canceled)

9. A method of filling an order for volumes of printed material, comprising:
(a) maintaining the informational content of a plurality of titles in computer accessible storage;
(b) maintaining an inventory of lightweight continuous roll web paper;
(c) receiving, from a customer, an order for a specified number of bound volumes of a particular one of said titles the informational content of which is stored in computer accessible storage;
(d) drawing on said inventory of lightweight continuous roll web paper to feed said paper to a printer which uses a printing technique which does not create substantially raised printed characters such as an ink jet printer;
(e) printing, using printing technique which does not create substantially raised printed characters, on said lightweight web continuous roll paper to produce printed paper with informational content of said particular one from said titles and substantially corresponding to said specified number of volumes;
(f) binding said printed paper into said specified number of volumes to produce substantially said specified number of bound volumes; and
(g) shipping said bound volumes to said customer without maintaining said volumes in inventory.

10. A method as in claim 9, wherein said lightweight paper weighs generally about 39-50 grams per square meter, coated or uncoated.

11. A method as in claim 9, wherein said lightweight papers weighs generally about 27-40 grams per square meter, coated or uncoated.

12. A method as in claim 9, wherein said informational content is made available to said customer in an editable format and said customer is given the opportunity to edit said content.

13. A method as in claim 12, wherein said information content is composed of the entire text of the Bible, the Torah, and other pertinent religious texts together with numerous types and examples of illustrations, lessons and commentary associated with various parts of the Bible or said religious texts and available for selection by said customer.

14. A method as in claim 13, wherein said religious text is composed of passages which said customer is given the opportunity to emphasize for the intended recipient.

15. A method as in claim 14, wherein said religious text is composed of passages which said customer is given the opportunity to emphasize for the intended recipient by highlighting, underlining, or otherwise noting as being special.

16. A method as in claim 14, wherein said highlighted or underlined passages are available to said customer and said customer is given the opportunity to print said highlighted or underlined passages in different colors.

17. A method as in claim 13, wherein said informational content is composed of a list of possible problems experienced by the intended recipient and available for selection by said customer.

18. A method as in claim 13, wherein said informational content is available to said customer in an editable format and said customer is given the opportunity to generate a personalized message with sections emphasized which relate to said intended recipient's age and problems.

19. A method as in claim 18, wherein said customer is given the opportunity to further customize said personalized message by adding personal information and illustrations, and by adding his/her own photograph by having the same scanned and inputted into the computer accessible storage.

20. A method as in claim 9, wherein said paper is coated.

21. A method as in claim 9, wherein said paper is fed using a web paper feeding technique.

22. A method of filling an order for volume or volumes of printed material, comprising:
(a) maintaining the informational content of a plurality of titles in computer accessible storage;
(b) maintaining an inventory of lightweight continuous roll web paper;
(c) receiving, from a customer, an order for a specified number of bound volume or volumes of a particular one of said titles the informational content of which is stored in computer accessible storage;
(d) drawing on said inventory of lightweight continuous roll web paper to feed said paper to a printer which uses a printing technique which does not create substantially raised printed characters such as an ink jet printer;
(e) printing, using printing technique which does not create substantially raised printed characters, on said lightweight web continuous roll paper to produce printed paper with informational content of said particular one from said titles and substantially corresponding to said specified number of volume or volumes;
(f) binding said printed paper into said specified number of volumes to produce substantially said specified number of bound volume or volumes; and
(g) shipping said bound volume or volumes to said customer without maintaining said volume or volumes in inventory;
(h) wherein said information content is made available to said customer in an editable format and said customer is given the opportunity to edit said content.

23. (canceled)

24. (canceled)

25. (canceled)

26. (canceled)

27. (canceled)

28. (canceled)
